(19) United States
(12) Patent Application Publication
(10) Pub. No.: US 2026/0178769 A1
(43) Pub. Date: Jun. 25, 2026

(54) DIFFERENTIAL PRIVACY USING PROBABILISTIC DATA STRUCTURES

(71) Applicant: Adobe Inc., San Jose, CA (US)

(72) Inventors: Sandeep Anant Nawathe, Sunnyvale, CA (US); Yeshwanth Vijayakumar, Sunnyvale, CA (US); Tung Thanh Mai, San Jose, CA (US); Kevin James Wong, San Francisco, CA (US); Anup Bandigadi Rao, San Jose, CA (US); Antonio Cuevas, Mountain View, CA (US)

(73) Assignee: Adobe Inc., San Jose, CA (US)

(21) Appl. No.: 18/988,635

(22) Filed: Dec. 19, 2024

(51) Int. Cl. G06F 21/62; G06F 16/22

(52) U.S. Cl. CPC G06F 21/6245; G06F 16/2228

(57) ABSTRACT

Differential privacy techniques using probabilistic data structures are described. In one or more examples, a dataset record is received and a sketch is generated as a probabilistic data structure by applying noise to the dataset record. The sketch is communicated to be stored in a database that supports a probabilistic result to a query operation.

### BACKGROUND

Confidential information of users is under constant attack by malicious parties that attempt to expose and exploit this potentially valuable information. Confidential information, for instance, may include personally identifiable information used to identify a user, itself, involve access to accounts associated with the user, and so forth. Data breaches have become common in which confidential information is exposed of millions and even billions of users due to hacking from these malicious parties. Because of this, users are less willing to share this information and are concerned with how this information is used even by legitimate service provider systems.

Techniques have been developed to address this unwillingness that limit user tracking, reject use of “cookies,” and so forth. As a result, computational functionality that relies on this data may fail for its intended purpose. This failure results in inaccuracies caused by incomplete data, causes inefficient use of computational resources that are implemented to overcome these technical challenges, and so forth.

### SUMMARY

Differential privacy techniques using probabilistic data structures are described. In one or more examples, a dataset record is received and a sketch is generated as a probabilistic data structure by applying noise to the dataset record. The sketch is communicated to be stored in a database that supports a probabilistic result to a query operation.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

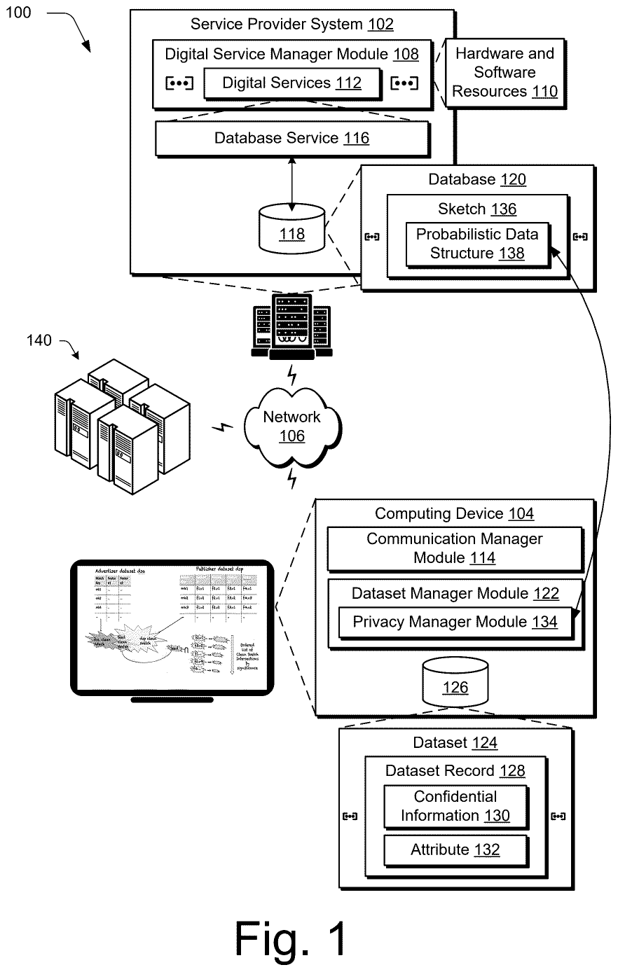

FIG. 1 is an illustration of a digital medium environment in an example implementation that is operable to employ data privacy management techniques described herein as implemented using a probabilistic data structure.

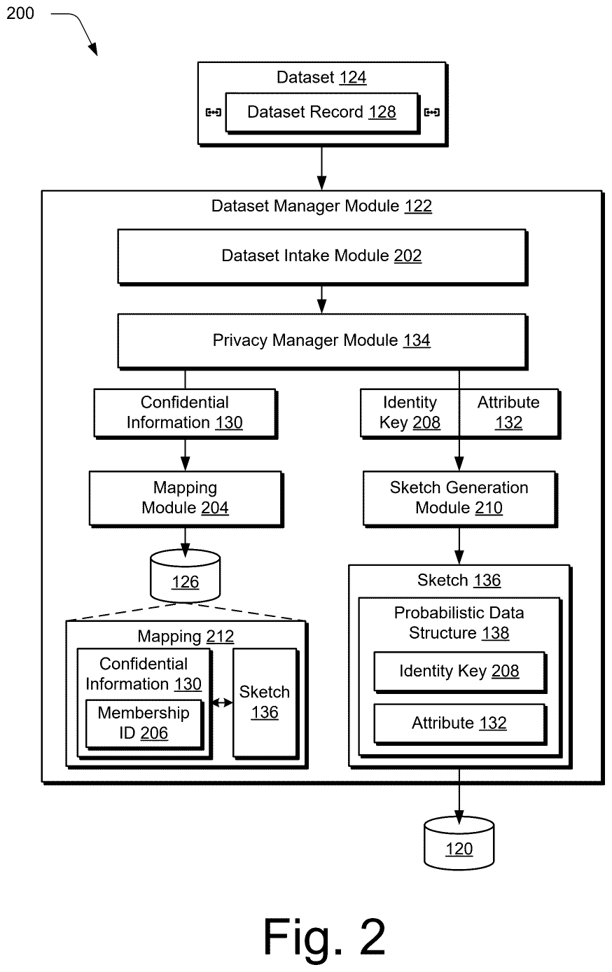

FIG. 2 depicts a system in an example implementation showing operation of a dataset manager module of FIG. 1 in greater detail.

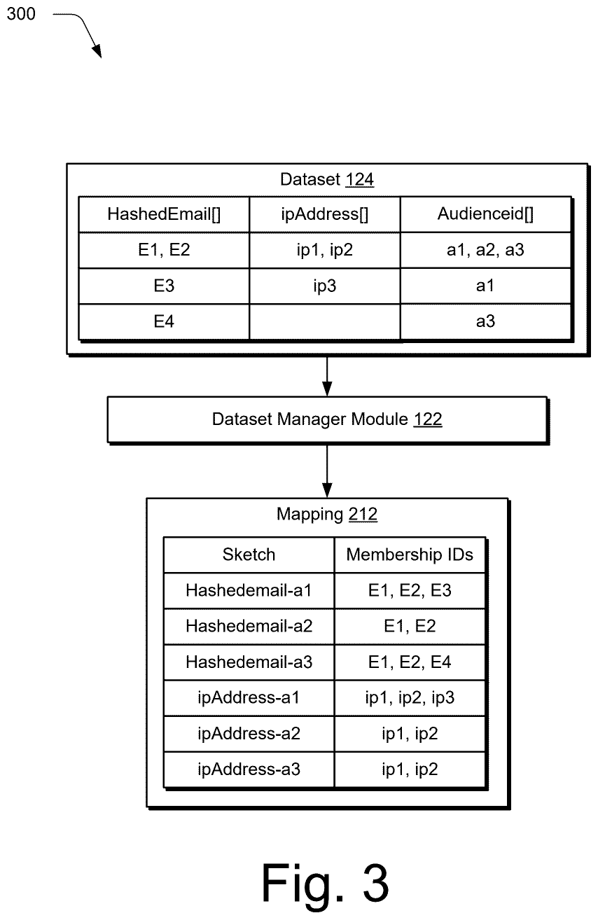

FIG. 3 depicts a system in an example implementation showing operation of a dataset manager module of FIG. 2 in greater detail as forming a sketch and corresponding mappings with respect to confidential information indicating which entities are associated with the sketches.

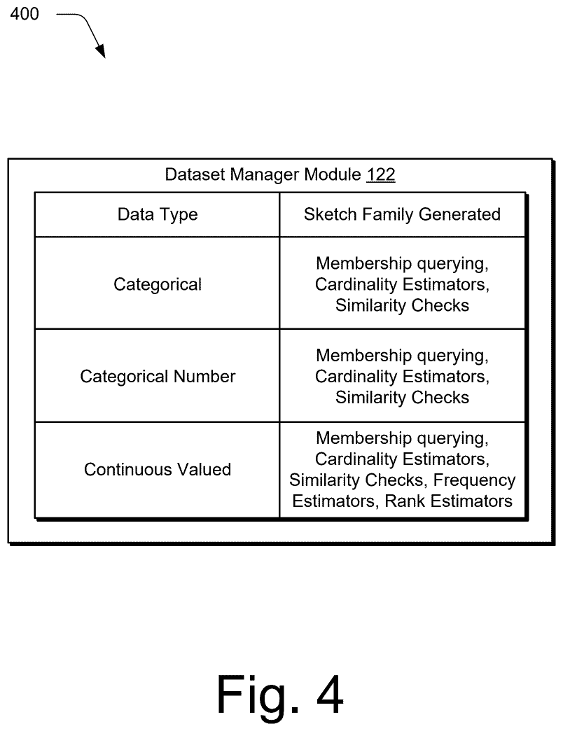

FIG. 4 depicts a table in an example implementation showing types of sketches generated for respective data types by a dataset manager module.

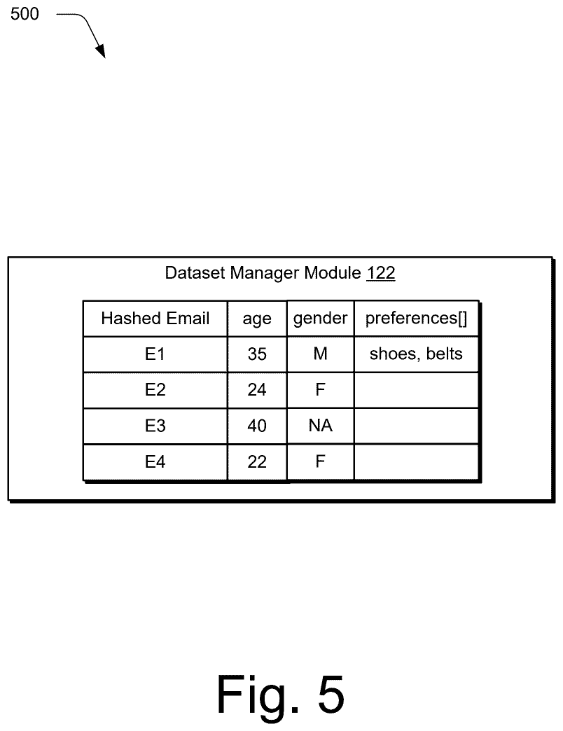

FIG. 5 depicts an example implementation of sketch generation methodology employed by a dataset manager module.

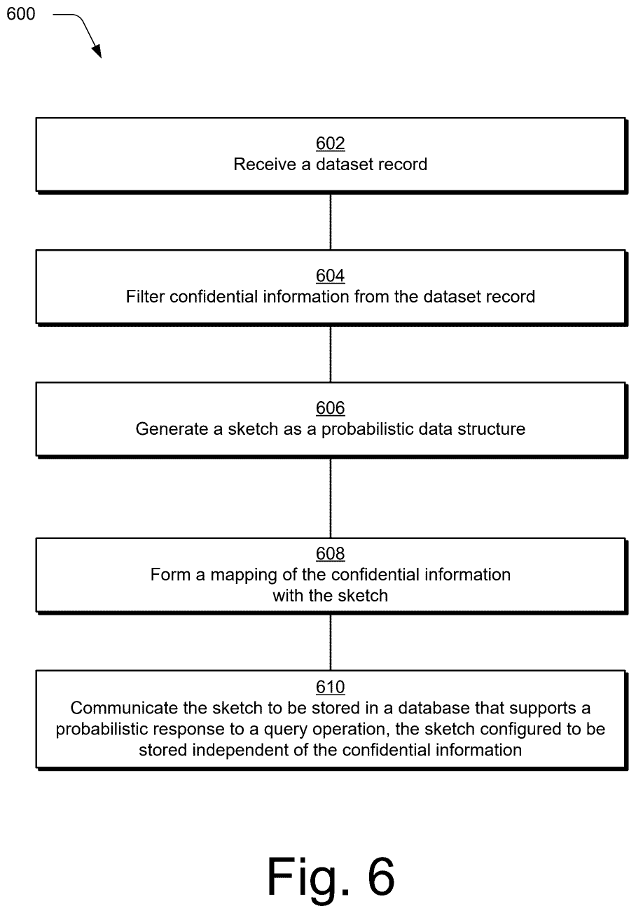

FIG. 6 is a flow diagram depicting an algorithm as a step-by-step procedure in an example implementation of operations performable for accomplishing a result of data privacy management utilizing sketch generation and mapping formation.

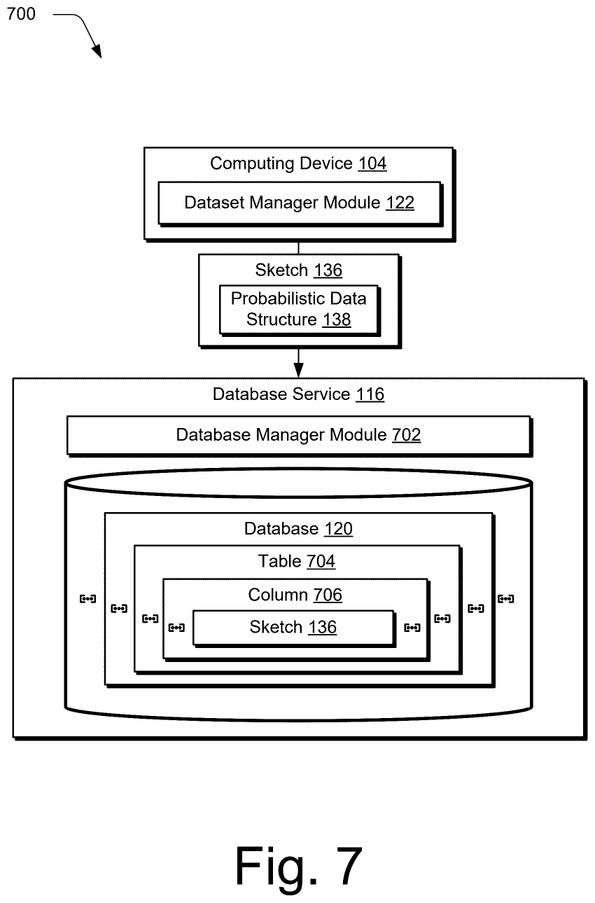

FIG. 7 depicts a system in an example implementation showing a database structure of a database having probabilistic data structures of FIG. 1 usable to maintain a sketch from a computing device without exposing confidential information.

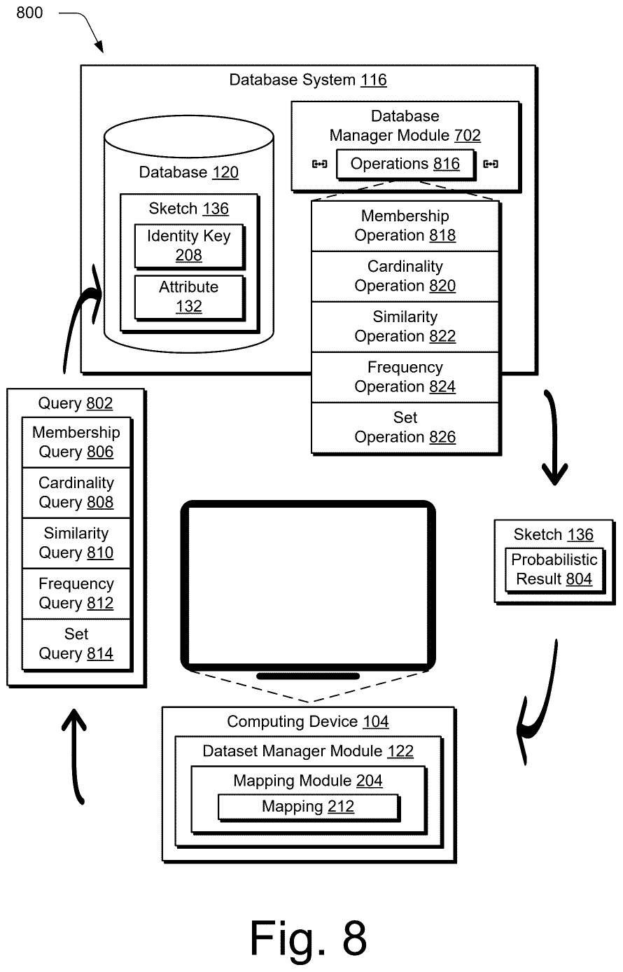

FIG. 8 depicts a system in an example implementation showing generation of a query by a computing device and generation of a probabilistic result as a response to the query by the database system.

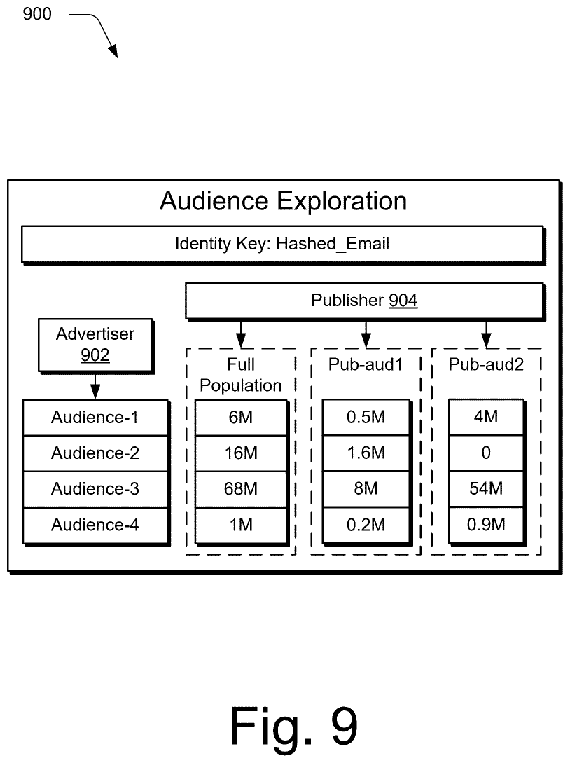

FIG. 9 depicts an example implementation involving audience exploration to determine audience overlaps between an advertiser and a publisher.

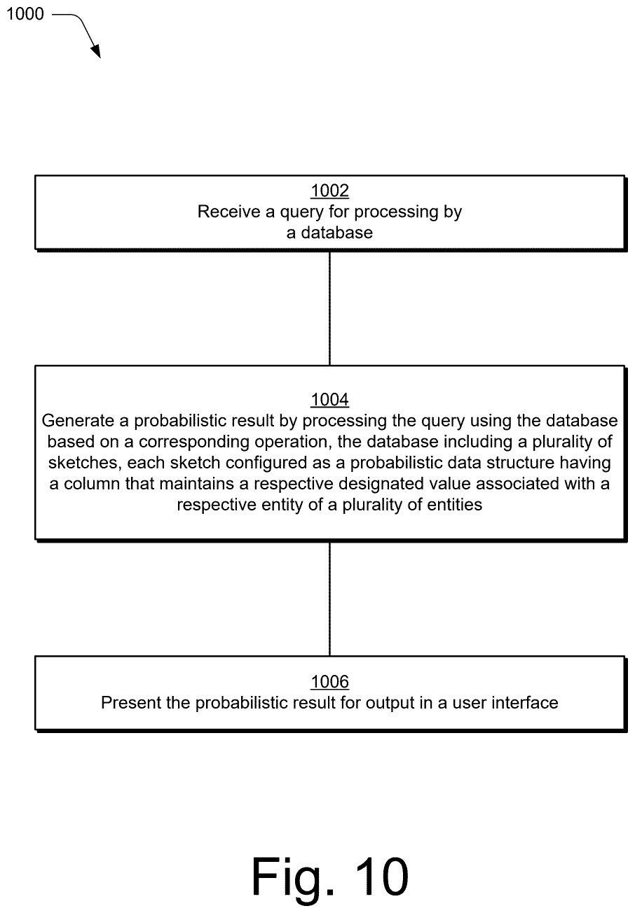

FIG. 10 is a flow diagram depicting an algorithm as a step-by-step procedure in an example implementation of operations performable for accomplishing a result of query processing using a database having probabilistic data structures.

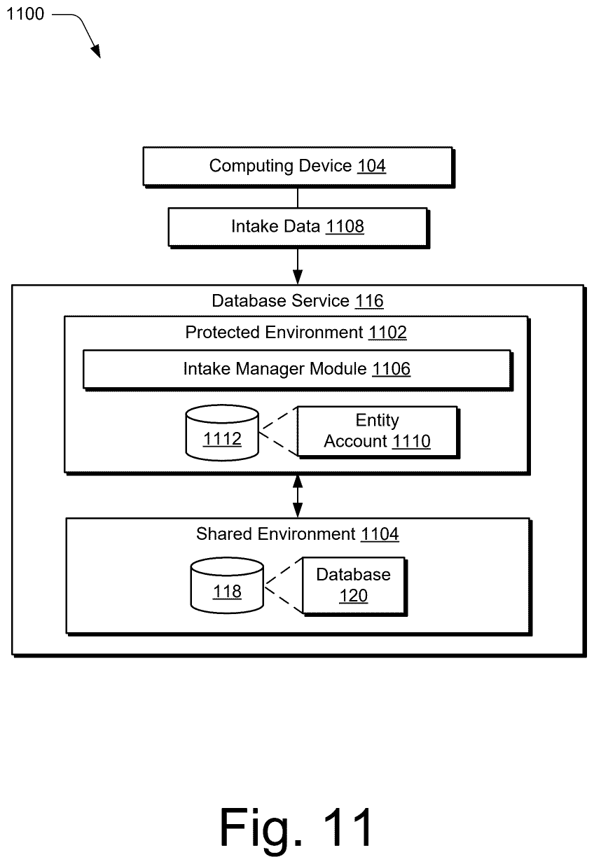

FIG. 11 depicts a system in an example implementation in which a database service implements onboarding and intake as part of a collaboration system.

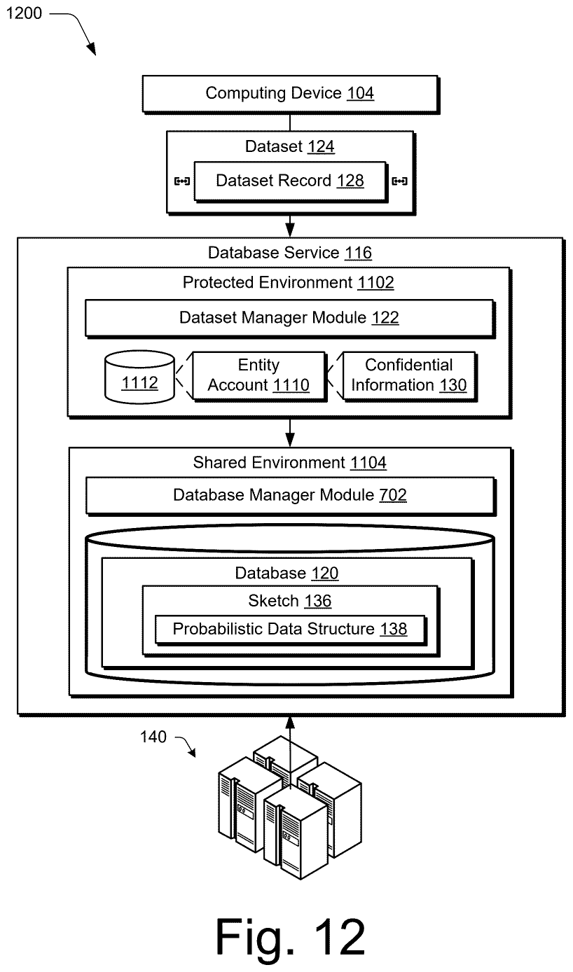

FIG. 12 depicts a system in an example implementation in which a database service implements sketch generation within a protected environment and sketch sharing within a shared environment as part of a collaboration system.

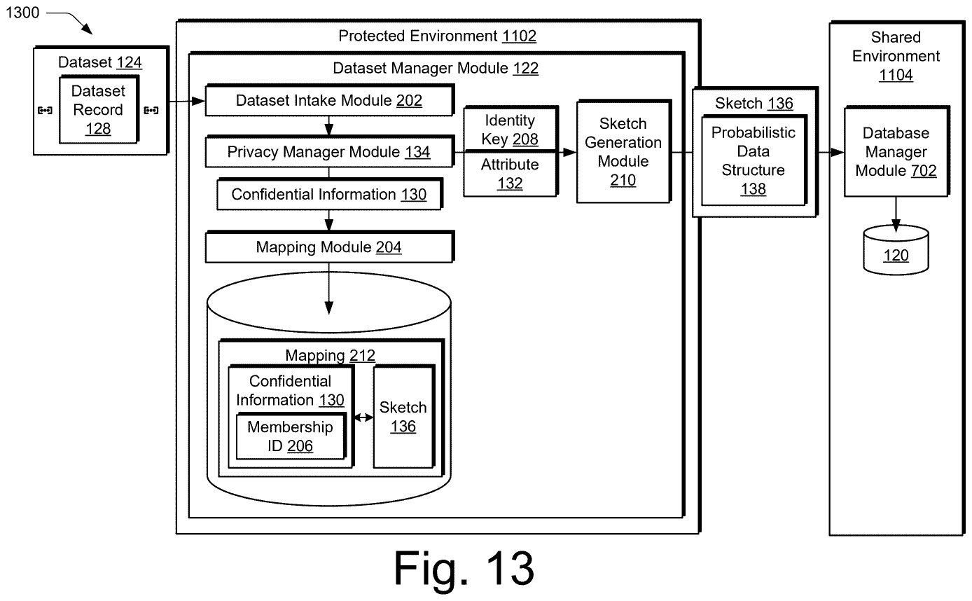

FIG. 13 depicts a system in an example implementation in which a dataset manager module of the database service implements sketch generation within a protected environment.

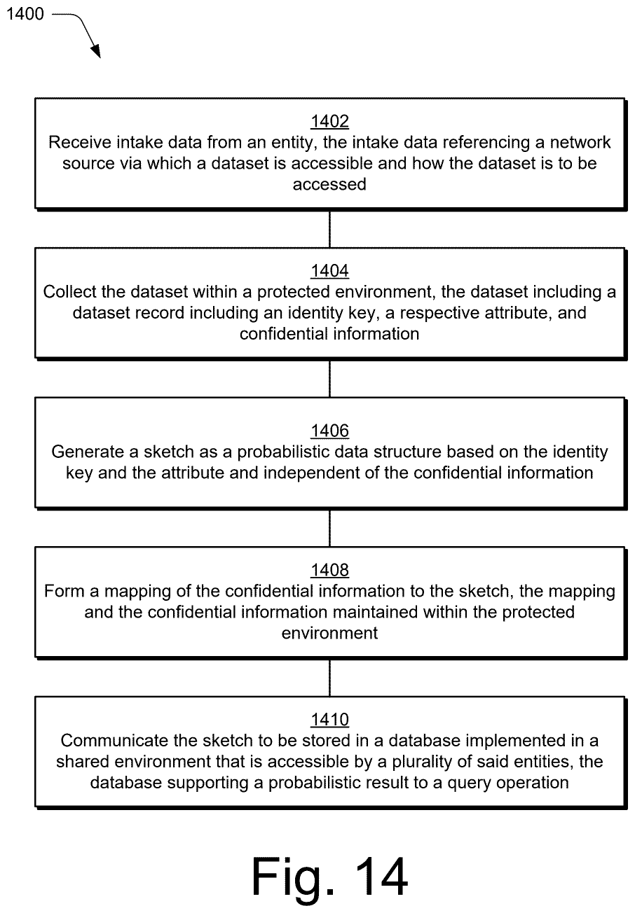

FIG. 14 is a flow diagram depicting an algorithm as a step-by-step procedure in an example implementation of operations performable for accomplishing a result of entity intake by a collaboration system.

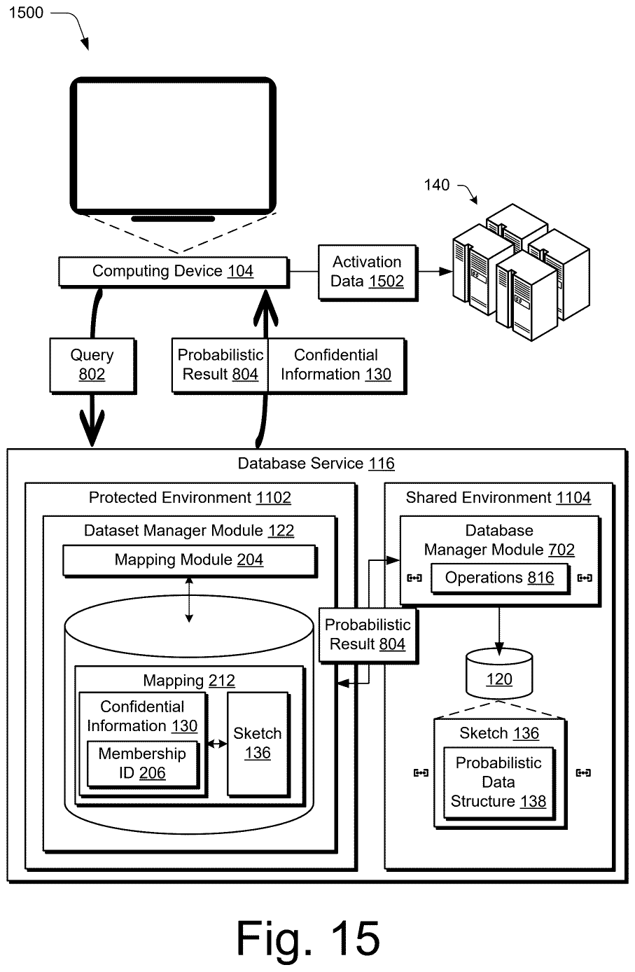

FIG. 15 depicts a system in an example implementation of a collaboration system that supports queries and probabilistic results to the queries without exposing confidential information.

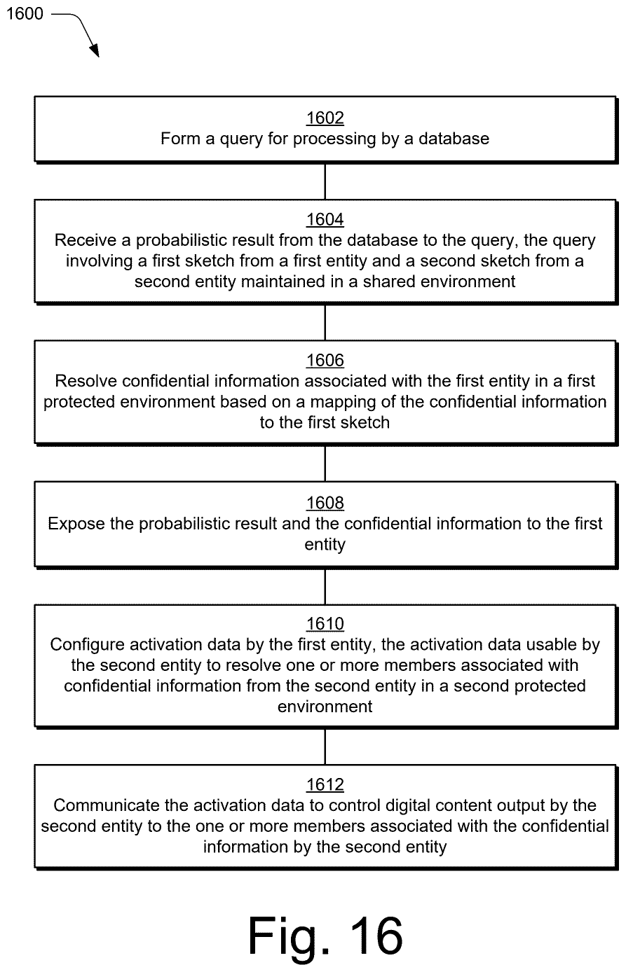

FIG. 16 is a flow diagram depicting an algorithm as a step-by-step procedure in an example implementation of operations performable for accomplishing a result of collaboration between entities using protected and shared environments that leverage probabilistic data structures.

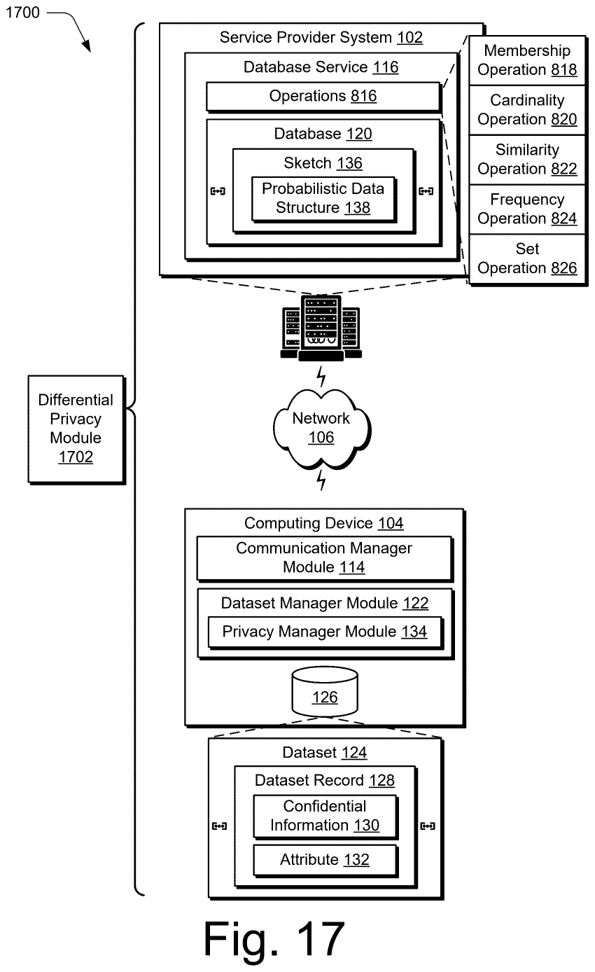

FIG. 17 depicts a system in an example implementation of enhancing probabilistic data structures using differential privacy.

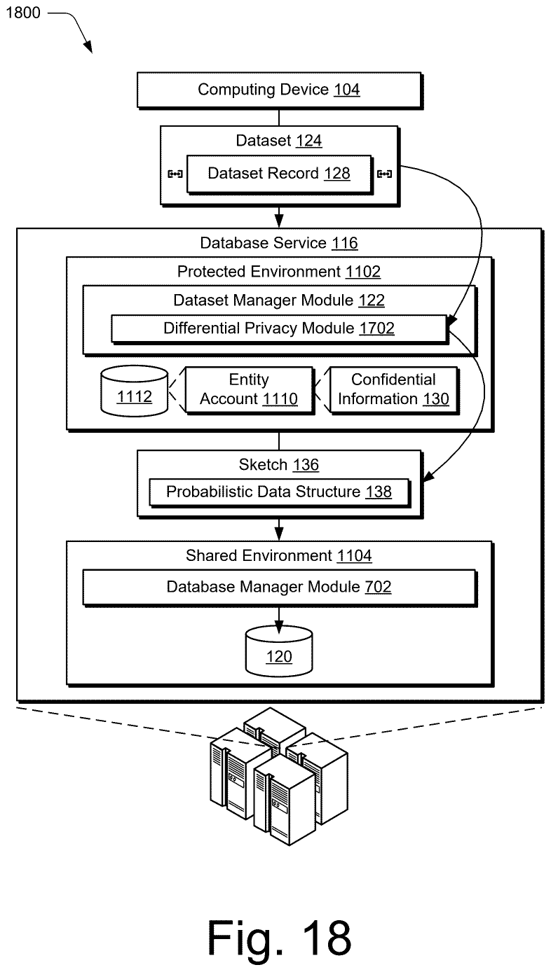

FIG. 18 depicts a system in an example implementation showing sketch generation as a probabilistic data structure as implementing differential privacy.

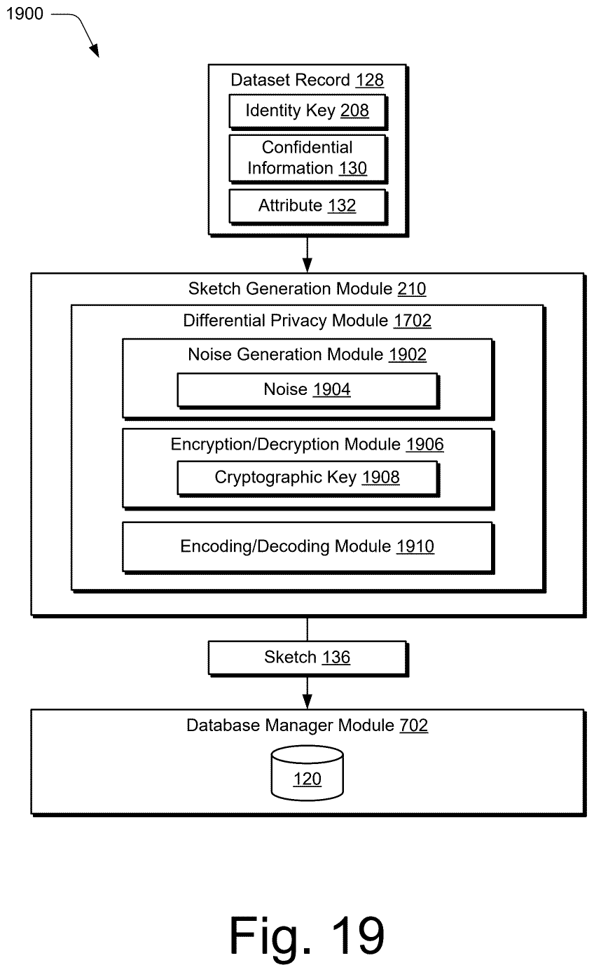

FIG. 19 depicts a system in an example implementation showing operation of the differential privacy module of FIG. 17 in greater detail as part of sketch generation.

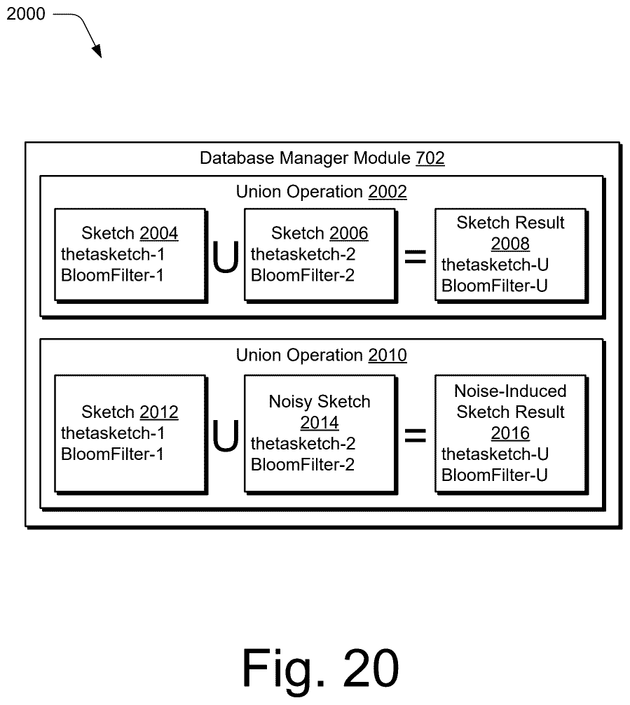

FIG. 20 depicts a system in an example implementation showing performance of union operations by the database manager module using sketches.

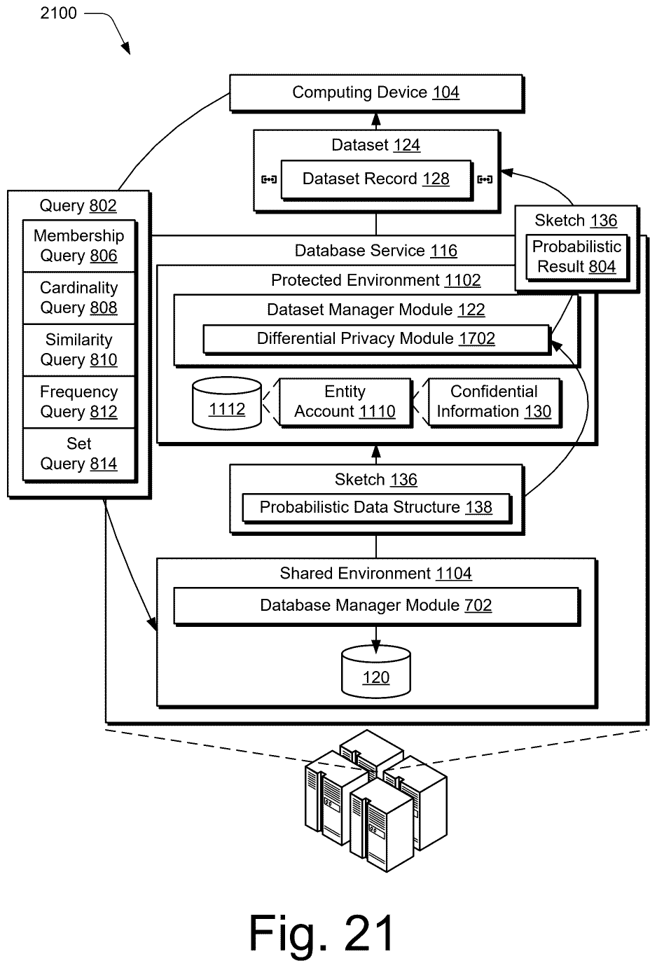

FIG. 21 depicts a system in an example implementation showing sketch generation as probabilistic data structure as implementing differential privacy in a probabilistic result to a query.

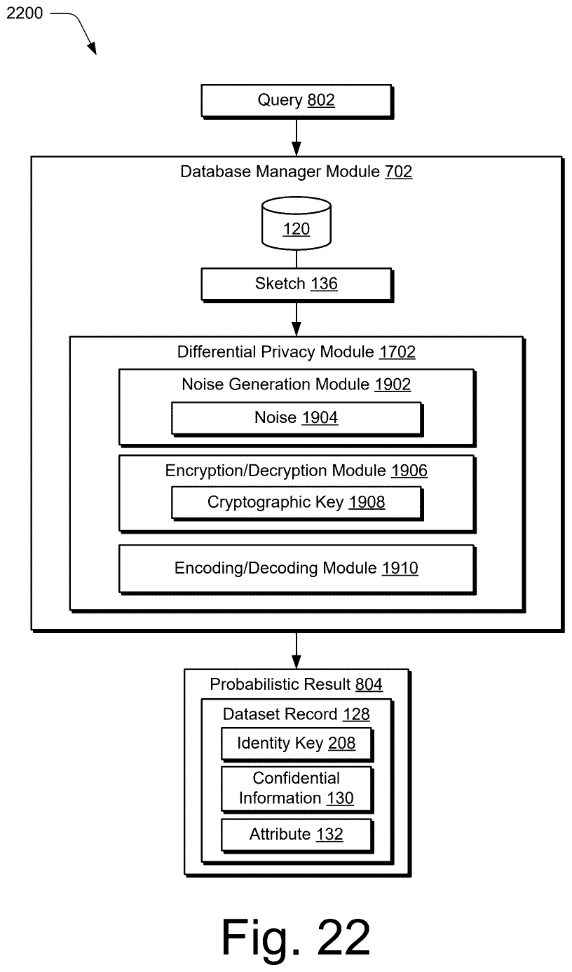

FIG. 22 depicts a system in an example implementation showing operations of a database and a result of those operations being processed using differential privacy in a probabilistic result to a query.

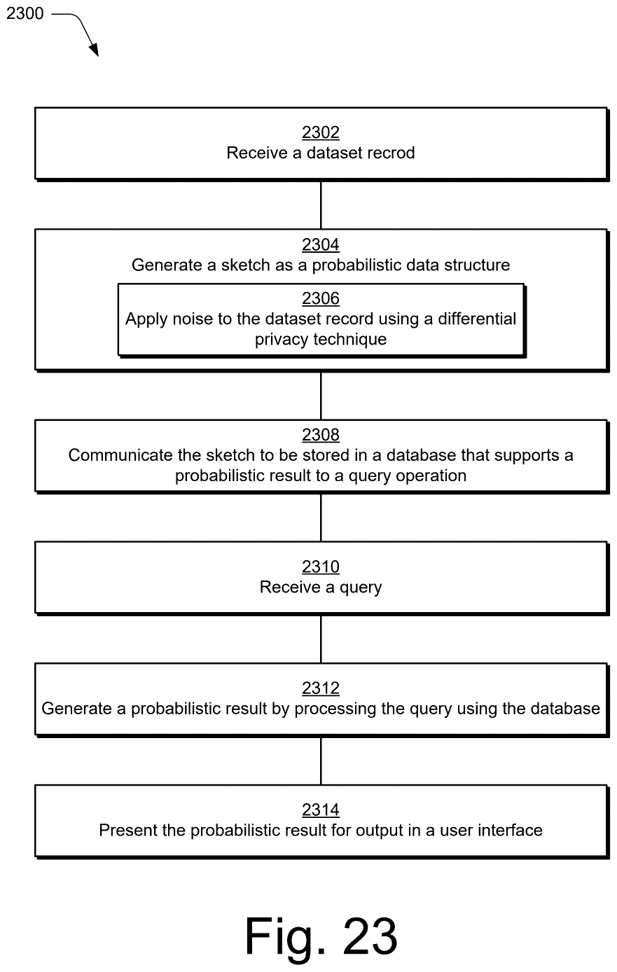

FIG. 23 is a flow diagram depicting an algorithm as a step-by-step procedure in an example implementation of operations performable for accomplishing a result of differential privacy using probabilistic data structures.

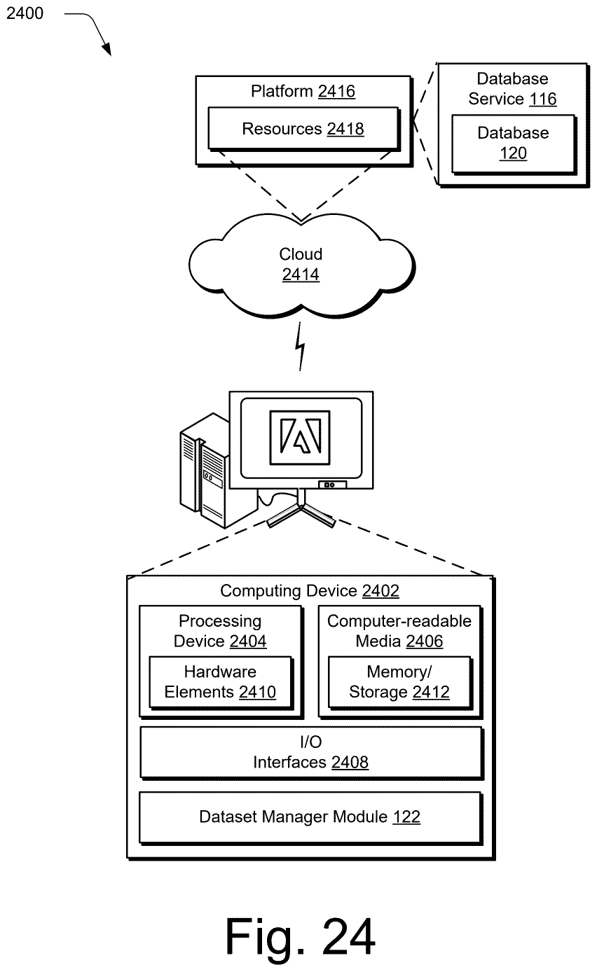

FIG. 24 illustrates an example system that includes an example computing device that is representative of one or more computing systems and/or devices that implement the various techniques described herein.

### DETAILED DESCRIPTION

### Overview

Confidential information refers to a variety of information types, including information usable to identify a user also known as “personally identifiable information,” identify membership in particular audiences, potentially sensitive information (e.g., medical information), and so forth. Examples of personally identifiable information, for instance, include a full legal name, nickname, birthday, social security number, passport number, email address, phone number, home address, financial information, and even biometric data such as facial recognition data, retinal scans, fingerprints, and so forth. Additional examples include membership in a particular audience.

As previously described, data breaches caused by malicious parties have resulted in the compromise of millions and even billions of instances of confidential information. In order to protect this information, privacy regulations and other privacy related considerations have been enacted to limit what user data is available for collection. These considerations have been addressed in a variety of ways through local privacy settings of a respective computing device, cookie-related changes in which browsers block cookie storage, and so forth.

Selection of an option “do not track,” for instance, restricts collection of navigation data of a user between websites, applications, and so forth. Likewise, removal of support for third-party cookies by browsers also limits an ability of a provider of the cookie to gain valuable user insight usable to track user navigation through pages of a website, navigation between websites, and so forth. Consequently, computational functionality that is configured to leverage this insight often fails and is inaccurate, e.g., recommendation engines, digital content output control functionality, search engines, and so forth.

Accordingly, data privacy management techniques are described herein that address these and other technical challenges in maintaining and sharing data that may contain confidential information. The data privacy management techniques, for instance, are configurable to leverage a probabilistic data structure as a privacy-safe, efficient, and scalable technique in support of data collaboration and query execution. As a result, these privacy-management techniques leverage use of a database having probabilistic data structures and data collaboration systems to ensure privacy regulation compliance as well as adapt to an ever-changing landscape in how user insight is gained.

To do so, probabilistic data structures and a database having probabilistic data structures are employed that do not include confidential information while maintaining data associated with the confidential information through the use of a “sketch.” A sketch employs a probabilistic data structure that is used to represent data in a condensed form. Sketches, for instance, employ algorithms (e.g., a Bloom filter, a Theta Sketch, or a MinHash), that support data representation without storing row-level information containing the confidential information, which ensures privacy by eliminating use of user identities, user audiences, or other confidential information. By storing a sketch independent of row-level data, recovery of a corresponding user, entity, or other confidential information associated with the data is not possible. Thus, a database having probabilistic data structures (e.g., the sketch) does not support direct identification of the confidential information. As a result, these techniques support compliance with privacy regulations and eliminate a risk of data leakage.

Sketches are also configurable to represent data in a highly condensed form, thereby reducing an amount of data that is stored and processed. This efficiency supports faster query execution and efficient use of computational resources. Conventional queries that could take days to process by a computing device (e.g., set operations), for instance, are performable in real time using the techniques described herein.

Additionally, the condensed nature of sketches enables efficient multi-cloud, multi-region implementation as well as multiparty collaboration. Therefore, seamless data sharing and query execution is supported across different platforms and regions. In this way, use of sketches as probabilistic data structures as well as databases having probabilistic data structures support a robust and scalable solution to the technical challenges involved with confidential information. Further discussion of these and other examples is included in the following sections and shown in corresponding figures.

### Term Examples

A “probabilistic data structure” is a specialized data structure that is configurable to provide probabilistic responses to a query. A probabilistic data structure, for instance, is configurable to define a probability distribution over possible database instances, e.g., possible worlds.

A “Bloom Filter” is an example of a probabilistic data structure that is configurable to test when an element is or is not a member of a set.

A “MinHash” is an example of a probabilistic data structure that is configured to estimate similarity between two or more sets. MinHash works by hashing each element in a set using one or more hash functions. For each hash function, a minimum hash value is selected. Similarity between the set is estimated by comparing the selected minimum hash values.

A “count-min sketch” is an example of a probabilistic data structure that is configurable to estimate a frequency of elements in a dataset.

A “HyperLogLog” is an example of a probabilistic data structure usable to estimate a number of distinct elements in a data set.

A “Theta Sketch” is an example of a probabilistic data structure that is usable for approximate distinct counting and set operation. Theta sketches support set operations such as union, intersection, and set difference.

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Data Privacy Management Environment

FIG. 1 is an illustration of a digital medium environment 100 in an example implementation that is operable to employ data privacy management techniques described herein as implemented using a probabilistic data structure to control confidential information access. The illustrated environment 100 includes a service provider system 102 and a computing device 104 that are communicatively coupled, one to another, via a network 106. Computing devices are configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 14.

The service provider system 102 includes a digital service manager module 108 that is implemented using hardware and software resources 110 (e.g., a processing device and computer-readable storage medium) in support of one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, data storage, and so forth. Examples of digital services include a social media service, streaming service, digital content repository service, database service, content collaboration service, and so on. Accordingly, a communication manager module 114 (e.g., network-enabled application) is utilized by the computing device 104 to access the one or more digital services 112 via the network 106. A result of processing using the digital services 112 is then returned to the computing device 104 via the network 106.

In the illustrated example, the digital services 112 are utilized to implement a database service 116. The database service 116 is illustrated in this example as accessing a storage device 118 that maintains a database 120 having probabilistic data structures 138. The computing device 104 is illustrated as including a dataset manager module 122 that is configured to manage exposure of a dataset 124 (e.g., also illustrated as stored in a storage device 126) to the database service 116.

The dataset 124, for instance, is formed using a plurality of dataset records, an example of which is depicted as dataset record 128. The dataset record 128 in this example includes confidential information 130 and an attribute 132. The dataset record 128, for instance, is associated with an item of digital content (e.g., an email, webpage, etc.) as an identity key (e.g., a column header) and the attribute 132 indicates whether a particular user interacted with the digital content, e.g., as row-level data. The confidential information 130 in this example is a membership identifier (ID) that identifies a particular entity (e.g., user) associated with the attribute 132 as row-level data for the respective identity key.

As previously described, hackers and other malicious parties continually attempt to expose the confidential information 130, e.g., the identification of the membership ID of a particular user in this example. To address these and other technical challenges such as “do not track” functionality and privacy blocking, the dataset manager module 122 employs a privacy manager module 134. The privacy manager module 134 is configured to maintain the confidential information 130 locally by the computing device 104 yet permit sharing of other parts of the dataset record 128 in support of a variety of functionalities, e.g., recommendation engines and so forth.

To do so, the privacy manager module 134 is configurable to form a sketch 136 having a probabilistic data structure 138. The probabilistic data structure 138 is configured to eliminate use of row-level data of the dataset record 128 through use of algorithms such as Bloom filters, MinHash, Theta Sketches, and so forth. This approach eliminates use of row-level information, which is the confidential information 130 in this example.

The probabilistic data structure 138 is configurable to represent the dataset record 128 in a reduced manner by condensing the dataset record 128 into a compact form by elimination of the row-level information. Elimination of row-level information thus significantly reduces an amount of data that is stored and processed, e.g., by the database service 116. For example, one hundred million rows of data on audiences may be condensed into approximately ten kilobytes of data through use of the probabilistic data structure 138 by the sketch 136.

In this way, the compact representation of the probabilistic data structure 138 by the sketch 136 enables efficient multi-cloud, multi-region, and multi-party collaboration, as the smaller data size allows for seamless data sharing and query execution across different platforms and regions. Additionally, the condensed data representation of the probabilistic data structure 138 allows for faster query execution, significantly improving processing speed when compared to conventional database techniques.

In a multi-collaboration scenario, the privacy manager module 134 of the dataset manager module 122 shares a sketch 136 having a probabilistic data structure 138 that is independent of the confidential information 130. An additional computing device 140 may perform similar operations, such that each of the computing devices 104, 140 are able to share data (e.g., attributes and identity keys associated with the confidential information 130) without exposing the confidential information 130. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Data Privacy Management

The following discussion describes data privacy management techniques that are implementable utilizing the described systems and devices through use of a probabilistic data structure. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 6 is a flow diagram depicting an algorithm 600 as a step-by-step procedure in an example implementation of operations performable for accomplishing a result of data privacy management utilizing sketch generation and mapping formation. In portions of the following discussion, reference is made in parallel to FIG. 6 along with a discussion of corresponding systems.

FIG. 2 depicts a system 200 in an example implementation showing operation of the dataset manager module 122 of the computing device 104 of FIG. 1 in greater detail. In this example, a data intake module 202 of the dataset manager module 122 receives a dataset record 128 (block 602), e.g., as part of a dataset 124. The dataset 124 may take a variety of forms, such as a comma separated value (CSV) file or other structure including a table. Other unstructured examples are also contemplated, e.g., in which a structure is then derived through additional processing using machine learning upon intake of the structured data. The data intake module 202 may therefore process the dataset 124 into a form that is compatible with the privacy manager module 134.

The privacy manager module 134 is then employed to filter confidential information 130 from the dataset record 128 (block 604). Each dataset record 128, for instance, includes a column having a corresponding identity key and attributes having data values within the column. The dataset record 128 also includes confidential information 130 associated with the attributes (e.g., as row-level data), e.g., identifying entities associated with the attributes as membership IDs. The membership IDs, for instance, are usable to identify respective user populations.

Accordingly, the privacy manager module 134 is configured in this example to filter the confidential information 130 from the dataset record 128 to form a redacted dataset that does not include the confidential information 130. The confidential information 130 is illustrated as being passed to a mapping module 204. As previously described, the confidential information 130 may take a variety of forms, such as a membership ID 206 as depicted in FIG. 2. An identity key 208 identifying a respective column of the dataset record 128 and associated attribute 132 taken from the dataset record 128 are passed as the redacted dataset by the privacy manager module 134 to a sketch generation module 210. Thus, the sketch generation module 210 in this example does not have access to the confidential information 130 when creating a sketch 136.

The sketch generation module 210 is configured to generate a sketch 136 as a probabilistic data structure 138 (block 606) independent of the confidential information 130. The probabilistic data structure 138, for instance, is based on the identity key 208 and the attribute 132 and is independent of the membership ID 206. Further, the attributes 132 in these examples are not sampled through use of the probabilistic data structure 138, but rather included in their entirety thereby improving accuracy over conventional techniques. Further discussion of sketch 136 generation by the sketch generation module 210 is described in relation to FIGS. 3-5 in the following discussion.

The mapping module 204 is configured to form a mapping 212 between the confidential information 130 and the sketch 136 (block 608). The mapping 212 is usable to resolve what confidential information 130 (e.g., the membership ID 206) corresponds with the sketch 136. The mapping 212 is maintained in storage device 126 locally at the computing device 104 and is not exposed outside of the computing device 104 in this example, thereby protecting the confidential information 130 from compromise by malicious parties.

The mapping 212 is therefore usable to resolve identification of a particular sketch 136 in a probabilistic result to a query processed by the database service 116 when received at the computing device 104. In this way, the database service 116 does not receive the confidential information 130 and thus is unable to determine an identity of the membership ID 206, thereby preserving privacy of a corresponding entity.

The sketch generation module 210 is configurable to leverage internal data structures for different types of data as part of generating the sketch 136. The sketch generation module 210, for instance, is configurable to detect a type of data included in the dataset record 128 to leverage an internal data structure that is selected based on that data type to form one or more sketches 136.

The sketch generation module 210, for example, is configured to identify each column in the dataset 124 (e.g., “i0,” “i1,” “2”) having an associated identity key 208 (e.g., column header) of the dataset record 128 and associated attribute 132 with a membership ID 206 supplying row-level information. The sketch generation module 210 is configurable to identity a threshold number (e.g., “k”) of distinct values based on saliency, i.e., the “most salient” values. The value of the threshold number may be based on a variety of considerations, examples of which include storage and query considerations.

Different data types in this example involve different techniques used by the sketch generation module 210 to form the sketch 136 and thus different internal data structures. For categorical string values, for instance, the sketch generation module 210 identifies the “top k” strings that have a highest amount of cardinality in a subject column, with other string values being grouped together, e.g., as “other.” Thus, the sketch generation module 210 detects that the database record 128 involves categorical strings and, responsive to the detecting, identifies a threshold number of the categorical strings based on cardinality. The sketch generation module 210 then forms a number of sketches 136 based on the threshold number of categorical strings. One or more of the categorical strings that are not included in the threshold number are grouped together.

In another example, the sketch generation module 210 detects that the dataset record 128 involves numerical values. In response, the sketch generation module 210 identifies a threshold number of the numerical values that are used to form the sketch 136 or “bucketizes” the numerical values into a “k” number of buckets for inclusion in the sketch 136.

FIG. 3 depicts a system 300 in an example implementation showing operation of the dataset manager module 122 of FIG. 2 in greater detail as forming a sketch and corresponding mappings to confidential information indicating which entities are associated with the sketches. The dataset 124 includes three columns in this example, the “hashEmail[ ]” and “ipAddress[ ]” as examples of identity keys, while the “audienceid[ ]” column includes membership IDs, and values of respective attributes 132 included in respective columns. Therefore, audienceID[ ] “a1” is associated with hashedemails[ ] “E1, E2, E3.” Likewise, a hashed email “E3” and a corresponding IP address “ip3” is associated with audience “a1.”

In this example, the membership ID 206 is a simple string having a categorical value indicating membership of an audience with respective attributes in columns associated with respective identity keys. Therefore, the sketch and members illustrated in the mapping 212 enumerate different combinations of hashed emails and IP addresses associated with respective audiences.

Representation of various probabilistic data structures are denotable using a hash, for example, in which the hashed email is used as an identity key for an audience to be indicated by the sketch. Therefore, each hashed email associated with audience “a1” is grouped and used to create a “clean” sketch representation for “a1.” Membership IDs indicate “E1,” “E2,” and “E3” are members of the corresponding sketch, e.g., “hashEmail-a1” as illustrated. This process is also repeated for the IP addresses in the illustrated example.

In this way, the rows and columns are effectively pivoted into a sketch-based inverted index. The mapping 212 therefore provides a cross reference between the sketch and corresponding membership IDs that is usable to resolve which entities associated with respective membership IDs are associated with respective sketches 136 without exposing this relationship outside of the computing device 104.

FIG. 4 depicts a table 400 in an example implementation showing types of sketches generated for respective data types by a dataset manager module 122. As previously described, the dataset manager module 122 is configured to employ internal data structures as a guide to sketch generation. Therefore, the dataset manager module 122 is configurable to select from a plurality of internal data structures based a data type to be processed to form a respective sketch 136. In this way, the dataset manager module 122 is configurable to generate sketches 136 having a variety of configurations.

In a first example of a “categorical” data type, sketches are generated that support “membership querying,” “cardinality estimators,” and “similarity checks.” For a second example of a “categorical number” data type, sketches are also generated that support “membership querying,” “cardinality estimators,” and “similarity checks.” In a third example of “continuous valued” data type, sketches are generated that support “membership querying,” “cardinality estimators,” “similarity checks,” “frequency estimators,” and “rank estimators.” In this way, the internal data structures act as a guide in sketch generation by the dataset manager module 122. A variety of other examples are also contemplated.

For a simple scenario that does not involve dimensionality of the designated values, the following operations are performed by the dataset manager module 122, and more particularly the sketch generation module 210:
For each row in the dataset 124:
   For each audience “Ai” in audience list (A1, A2, . . . , An);
      For Identity Type in [HashedEmail, ipAddress];
         Add each of the IDs of “IdentityType” in row to “Ai-identity type” sketch.
            This results in the creation of sketches as variations of cardinality estimators, e.g., Theta Sketches, HyperLogLog, and Membership based sketches such as Bloom filters on an audience ID/identity type granularity. In this example, the audience ID maps to a categorical type.

FIG. 5 depicts an example implementation 500 of sketch generation by a dataset manager module 122 that addresses dimensional values in a dataset 124. In a scenario involving dimensional values, in addition to the audience data, extra dimensional information is added to provide additional information. In the illustrated example, “Hashed Email” is associated with additional information including “age,” “gender,” and “preferences [ ].” Therefore, data types for “age” include “categorical number,” for “gender” include “categorical,” and for “preferences” include “categorical.”

The granularity of sketches generated by the dataset manager module 122 is configurable as a combination of audience ID, identity type, dimension name, and dimension discretized value. The following operations are performed by the dataset manager module 122, and more particularly the sketch generation module 210:
For each row in the dataset 124:
   For each audience “Ai” in audience list (A1, A2, . . . , An);
      For Identity Type in [HashedEmail, ipAddress];
         Add each of the IDs of “IdentityType” in row to “Ai-identity type dimension value” sketch.

In a scenario involving continuously valued data, the sketch generation module 210 preprocesses and discretizes the data in terms of percentiles “p0,” “p10,”, “p20,” . . . , “p90,” “p100” where “p100” is a maximum value and “p0” is a minimum value. This permits the sketch generation module 210 to discretize the continuously valued attributes into buckets, i.e., “bucketize” the values of the attributes.

For a timeseries data type, the dataset 124 includes a timestamp column and corresponding data that is a subject of the timestamp. Therefore, each row of the dataset 124 may include the following:
Identity type, e.g., hashed email, IP address that generated the data;
Timestamp of the event;
Metric, e.g., sum of impressions;
Metric value; and
Optional dimensional fields such as “adset,” “adgroup,” and so on.

The following operations are performed by the dataset manager module 122, and more particularly the sketch generation module 210 in a timeseries scenario:
For each row in the dataset 124:
   For each metric “Mi” in a metric list (M1, M2, . . . , Mn);
      For Identity Type in [HashedEmail, ipAddress];
         For each dimension field:
         For distinct metric aggregation value:
         Add each of the IDs of Identity Type in row to date-hour-identitytype-metric-metric-value-dimension-value sketch.
            The granularity of the sketches in this scenario supports queries such as “find a sum of each of the impression that occurred on 26 August Hour 2 for hashed emails” which would cause the database service 116 to return a corresponding sketch as a probabilistic result. Of note, the distinct value of the metric value is also encoded in the sketch in this example without sampling, which increases accuracy over conventional sampling based techniques.

Returning again to FIG. 2, the sketch 136 is then communicated for storage in a database 120 having probabilistic data structures 138 that supports a probabilistic result to a query operation. The sketch 136 is configured to be stored independent of identification of the entity (block 610) within a database having probabilistic data structures 138. In this way, the confidential information 130 is not exposed outside of the dataset manager module 122 and the service provider system 102.

FIG. 7 depicts a system 700 in an example implementation showing a database structure of the database having probabilistic data structures 138 usable to maintain a sketch 136 from a computing device 104 without exposing confidential information. The database service 116 includes a database manager module 702 configured to process queries using the database 120 and return probabilistic results to the queries using the sketches 136.

Each database service 116 includes one or more databases 120 having probabilistic data structures 138, in which each database 120 has probabilistic data structures 138 including one or more tables 704 having one or more columns 706 that are represented, respectively, using one or more sketches 136. This structure supports flexible creation of spaces for storing logically separated datasets and also supports schema definitions at a table/dataset level. The structures also support access controls. A schema of the tables 704 may be defined during design phase of the database 120 having probabilistic data structures 138 or auto inferred during loading of a dataset 124 to the table 704 by the database manager module 702.

Conventionally, a relational database is based on a mathematic notion of a set and corresponding set operations. The database 120 having probabilistic data structures 138 as described herein relies on a construction of a set using a sketch 136. A sketch 136, as previously described, is a probabilistic data structure that does not store individual dataset records 128 and thus does not record record-level identity, i.e., the membership ID or other confidential information. Although use of the sketch 136 and database 120 having probabilistic data structures 138 has been described for use in data privacy management, these techniques are also applicable to generic datasets 124 as well.

FIG. 8 depicts a system 800 in an example implementation showing generation of a query by a computing device and generation of a probabilistic result as a response to the query by the database service 116. In this example, the dataset manager module 122 is employed by the computing device 104 to generate a query 802. The database manager module 702 of the database service 116 then processes the query 802 using the database 120 having probabilistic data structures 138 to generate a probabilistic result 804. The response in the illustrated example includes a sketch 136 having the probabilistic result 804 that is selected and/or generated based on the query 802.

The query 802 is configurable in a variety of ways. In a first example, the query 802 is a membership query 806. The membership query 806 is usable to pose a question such as “is a particular ID present in a set?” e.g., using a Bloom filter as the probabilistic result 804. In a second example, the query 802 is configured as a cardinality query 808. A cardinality query 808 is usable to pose a question such as “How many IDs are present in a set?” with a probabilistic result 804 as a Theta Sketch, HyperLogLog, HyperLogLog++, and so on.

In a third example, the query 802 is configurable as a similarity query 810 structured to pose a question of “how similar are two sets?” A response to the query is formable using a MinHash as the probabilistic result 804. In a fourth example, the query 802 is configured as a frequency query 812 that is configured to pose a question such as “What is the frequency of occurrent of a particular event?” A response to the query is formable using a Count-Min sketch.

These queries support a variety of use cases. In a customer dataset example, the queries support materialization. For example, given a sketch and a list of identities, materialize a sketch as a set of identities that represent an audience corresponding to the sketch. To do so, the database manager module 702 performs repeated membership lookups and queries against the sketch.

In another example, an estimate of the cardinality of an audience set size is queried, in which the audience is represented using a corresponding sketch 136. In a further example, given two audiences (e.g., audience “A” and audience “B”), each as a respective sketch 136, build a new audience as a union of these two audiences, represented as a respective sketch 136. In yet another example, a look-a-like model is built of a seed audience based on a sketch 136. For frequency and reach, reach and frequency to a desired audience are estimated from advertising logs. A variety of other examples are also contemplated, such as a set query 814 usable to specify a respective set operation such as “union,” “intersect,” and so forth.

The database manager module 702, therefore, is configurable to perform a variety of operations 816 based on the types of queries received. Illustrated examples of which include a membership operation 818, cardinality operation 820, similarity operation 822, frequency operation 824, set operation 826, and so on. Examples of operations and corresponding outputs include:
isPresent(string element)→Boolean;
union(sketch)→sketch;
intersect(sketch)→sketch;
getEstimatedCardinality→long;
similarityScore(sketch)→double; and
aNotb(sketch)→sketch.
   The above examples include instances in which operations involve two or more sketches to generate a new sketch, e.g., union and intersect, a-not-b, and so forth.

A union operation, as an example of a set operation 826, may be performed by the database manager module 702 as a lossless operation through use of a sketch 136. Each of the components represented by the sketches 136, for instance, are added together to produce a lossless version of a net sketch, e.g., through use of Bloom filters, Theta sketches, and so forth.

An intersect operation, on the other hand, may be “lossy.” Theta sketches support a native intersect operation, for instance, which is usable to produce a new effective Theta sketch but may include additional error over any predecessors. A native intersect operation does not exist for a Bloom filter. Therefore, a deferred evaluation is performed through use of deferred execution to create a reference to an intersect operation and which Bloom filters are involved in that operation. When such a reference exists, deferred execution is performed by the database manager module 702, e.g., during a “isPresent” check on a sketch 136.

When an actual computation is performed as part of deferred execution, a truth table may be created with execution results, e.g., “isPresent” checks for each entry. In this way, deferred execution is usable to support operations not natively supported by particular types of probabilistic data structures through reference to respective sketches which are then performed at a later point in time, which is not possible in conventional techniques.

FIG. 9 depicts an example implementation 900 involving audience exploration to determine audience overlaps between an advertiser and a publisher. The identity key in this example is “hashed_email” and is based on a comparison of sketches generated, respectively, from datasets of an advertiser 902 and a publisher 904. The advertiser 902 audience (e.g., “a1,” “a2,” “a3,” “a4”) is indexed as a sketch 136 “sketch(a(i))” into a database having probabilistic data structures 138. A publisher 904 audience (e.g., “p1,” “p2,” “p3,” “p4”), likewise, is indexed into a sketch and stored in the database having probabilistic data structures 138 as “sketch(p(j)).”

In order to compute an overlap of these audiences, a cross product of two arrays of sketches is computed as follows:
let identity key=email;
for audience-sketch in [audience1-email-cleanSketch, audience2-email-Sketch, . . . ]:
   for publisher-sketch in [publisher-email-fullPopulationSketch, pub-aud1-email-Sketch . . . ]
      audience-sketch.getThetaSketch.intersect(publisher-sketch.getThetaSketch)
         Thus, in this example, a Theta sketch is retrieved from an audience sketch and a publisher sketch to perform the intersection.

In another example involving materialization, the following timeline of events has occurred:
t1-advertiser uploaded audience-a4 with hashed emails as a match key;
t2-advertiser compared a4 with other publisher audiences and chose a4 for activation using the same hashed email identity key; and
t3-advertiser materialized a temporary audience temp-audience based off audience-a4.
   Audience “a4” is then chosen for materialization by the publisher 904. To do so, the dataset manager module 122 retrieves a sketch 136 associated with the audience for identity key “hashed-email” from the database having probabilistic data structures 138. The dataset manager module 122 then accesses a corresponding probabilistic data structure 138 (e.g., Bloom filter) to generate and iterate through a list of each of the identifiers associated with the publisher 904. If “isPresent” is “yes” then it is added to a temporary activation list that contains the IDs and is sent to the publisher 904. A variety of other examples are also contemplated.

FIG. 10 is a flow diagram depicting an algorithm 1000 as a step-by-step procedure in an example implementation of operations performable for accomplishing a result of query processing using a probabilistic database. A query is received for processing by a database 120 (block 1002). A probabilistic result is then generated by processing the query using the database 120 based on a corresponding operation. The database 120 includes a plurality of sketches, each sketch configured as a probabilistic data structure having a column that maintains a respective attribute associated with a respective entity of a plurality of entities (block 1004). The probabilistic result is then presented for output in a user interface (block 1006).

In the following discussion, onboarding techniques are first described that involve obtaining intake data to setup a particular entity with access to a database service 116. Compute operations are also described within a shared environment (e.g., using operations 816 by a database manager module 702), which may then employ resolution of confidential information (e.g., membership IDs) within respective protected environments. Additional operation techniques include use of a probabilistic response to a query for audience materialization and activation without exposure of confidential information 130 outside of respective protected environments.

FIG. 14 is a flow diagram depicting an algorithm 1400 as a step-by-step procedure in an example implementation of operations performable for accomplishing a result of entity intake by a collaboration system. In portions of the following discussion, reference is made in parallel to FIG. 14 along with a discussion of corresponding systems.

FIG. 11 depicts a system 1100 in an example implementation in which a database service 116 implements onboarding and intake as part of a collaboration system. The database service 116 in this example includes a protected environment 1102 and a shared environment 1104. The protected environment 1102 is configured to restrict outside access by third parties to data and executable code contained within the protected environment 1102. In contrast, the shared environment 1104 is configured to permit outside access for data collaboration. Examples of a protected environment 1102 include a sandbox, a container, an isolated execution environment, an emulator, and so forth that are executable by a computing device using a processing device and storable using a computer-readable storage medium, e.g., that is non-transitory.

In the illustrated example, an intake manager module 1106 is executed within the protected environment 1102 to receive intake data 1108 from an entity, e.g., a computing device 104. The intake data 1108 references a network source via which a dataset is accessible and how the dataset is to be accessed (block 1402), e.g., a network address, IP address, application programming interface, and so forth. The intake data 1108 is also configurable to specify login credentials that are verifiable to gain this access, referencing data formats supported by the dataset 124 obtained from the network source, and so forth.

In response, the intake manager module 1106 then configures an entity account 1110 (stored in a storage device 1112) which includes forming a protected environment 1102 as associated with the respective entity, e.g., solely, such that outside access is permitted for that entity and other entities that have received permission from the entity. Once the entity account 1110 is formed, the database service 116 is configured to generate a sketch 136 to be maintained within the database 120 of the database service 116.

FIG. 12 depicts a system 1200 in an example implementation in which a database service 116 implements sketch generation within a protected environment and sketch sharing within a shared environment as part of a collaboration system. In this example, in contrast to FIG. 2, the dataset manager module 122 is implemented as part of the database service 116 within the protected environment 1102.

The dataset manager module 122 is configured to maintain the confidential information 130 within the protected environment 1102, e.g., within an entity account 1110. The database manager module 702, on the other hand, is executed within a shared environment 1104 to permit sharing of the sketch 136 without exposing the confidential information 130.

FIG. 13 depicts a system 1300 in an example implementation in which a dataset manager module 122 of the database service 116 implements sketch generation within a protected environment 1102. In this example, a data intake module 202 of the dataset manager module 122 collects the dataset 124 within a protected environment 1102. The dataset includes 128 a dataset record including an identity key, a respective attribute, and confidential information as previously described (block 1404). The dataset 124 may take a variety of forms, such as a comma separated value (CSV) file or other structure including a table. Other unstructured examples are also contemplated, e.g., in which a structure is then derived through additional processing using machine learning upon intake of the structured data. The data intake module 202 may therefore process the dataset 124 into a form that is compatible with the privacy manager module 134.

The privacy manager module 134 is then employed to filter confidential information 130 from the dataset record 128. Each dataset record 128, for instance, includes a column having a corresponding identity key and attributes having data values within the column. The dataset record 128 also includes confidential information 130 associated with the attributes (e.g., as row-level data), e.g., identifying entities associated with the attributes as membership IDs. The membership IDs, for instance, are usable to identify respective user populations.

Accordingly, the privacy manager module 134 is configured in this example to filter the confidential information 130 from the dataset record 128 within the protected environment 1102 to form a redacted dataset that does not include the confidential information 130. The confidential information 130 is illustrated as being passed to a mapping module 204 within the protected environment 1102. As previously described, the confidential information 130 may take a variety of forms, such as a membership ID 206 as depicted in FIG. 2. An identity key 208 identifying a respective column of the dataset record 128 and associated attribute 132 taken from the dataset record 128 are passed as the redacted dataset by the privacy manager module 134 to a sketch generation module 210. Thus, the sketch generation module 210 in this example does not have access to the confidential information 130 when creating a sketch 136.

The sketch generation module 210 is configured to generate a sketch 136 based on the identity key and the attribute and independent of the confidential information (block 1406). The probabilistic data structure 138, for instance, is based on the identity key 208 and the attribute 132 and is independent of the membership ID 206. Further, the attributes 132 in these examples are not sampled through use of the probabilistic data structure 138, but rather included in their entirety thereby improving accuracy over conventional techniques.

The mapping module 204 is configured to form a mapping 212 between the confidential information 130 and the sketch 136 (block 1408). The mapping 212 is usable to resolve what confidential information 130 (e.g., the membership ID 206) corresponds with the sketch 136. The mapping 212 is maintained in a storage device 126 within the protected environment 1102 and is not exposed outside of the protected environment 1102, thereby protecting the confidential information 130 from compromise by malicious parties.

The mapping 212 is therefore usable to resolve identification of a particular sketch 136 in a probabilistic result to a query processed by the database service 116 when received at the computing device 104. In this way, the database service 116 does not receive the confidential information 130 and thus is unable to determine an identity of the membership ID 206, thereby preserving privacy of a corresponding entity.

The sketch 136, as independent of the confidential information 130, is then communicated by the dataset manager module 122 to be stored in a database 120 within the shared environment 1104 (block 1410). Sharing of the sketches supports a variety of operations without exposing the confidential information 130, which is not possible in conventional techniques.

FIG. 16 is a flow diagram depicting an algorithm 1600 as a step-by-step procedure in an example implementation of operations performable for accomplishing a result of collaboration between entities using protected and shared environments that leverage probabilistic data structures. In portions of the following discussion, reference is made in parallel to FIG. 16 along with a discussion of corresponding systems.

FIG. 15 depicts a system 1500 in an example implementation of a collaboration system that supports queries and probabilistic results to the queries without exposing confidential information 130. This example begins by forming a query by a first entity (e.g., the computing device 104) for processing by a database 120 (block 1602). The query 802 in this example may be passed directly to the database manager module 702 within the shared environment 1104 or indirectly via the dataset manager module 122 within the protected environment 1102, e.g., the entity as “logged in” to an entity account 1110 and thus operates within the protected environment 1102.

The database manager module 702 then processes the query 802 using one or more operations 816 with respect to the database 120. A probabilistic result 804 is generated based on the processing as further described below by the database 120 based on the query 802. The query 802, for instance, may involve a first sketch from a first entity and a second sketch from a second entity maintained in the database 120 of the shared environment 1104 (block 1604), e.g., an intersect operation, a union operation, and so forth. The probabilistic result 804 is then received by the dataset manager module 122 within the protected environment 1102 from the database manager module 702 in the shared environment 1104.

The dataset manager module 122, through use of the mapping module 204, is then configured to resolve which of the confidential information 130 associated with the first entity (e.g., the computing device 104) in a first protected environment (e.g., protected environment 1102) based on a mapping of the confidential information 130 to the first sketch 136 (block 1606). The mapping 212, for instance, is configurable by the mapping module 204 to detect which of the confidential information 130 is represented in a respective sketch 136, e.g., membership IDs. In this way, the first entity is configurable to resolve member identity of known members but is not able to resolve identities of unknow members, e.g., from a second entity associated with the additional computing device 140.

The dataset manager module 122 is then configured to expose the probabilistic result 804 and the confidential information 130 to the first entity (block 1608), e.g., for presentation and display in a user interface. As a result, the computing device 104 is given insight into known membership IDs associated with the probabilistic result 804 and based on this may take a variety of actions.

The first entity associated with the computing device 104, for instance, configures activation data 1502. The activation data 1502 is usable by the second entity (e.g., additional computing device 140) to resolve one or more members associated with confidential information from the second entity in a second protected environment (block 1610). The second entity, for instance, also has an associated protected environment that is inaccessible by the computing device 104 via which a mapping is also maintained such that the second entity may resolve membership IDs known to the second entity.

The first entity may then communicate the activation data to control digital content output by the second entity to the one or more members associated with the confidential information by the second entity (block 1612), e.g., to control output of emails, instant messages, webpages, advertisements, and so forth. The activation data may be communicated directed by the computing device 104 to the additional computing device 140, indirectly through the database service 116 in order to resolve the membership IDs and any other confidential information within a respective protected environment, and so forth.

Thus, in these examples the collaboration system generates sketches for each participant that shares access within the shared environment 1104. The sketches for any entity are generated independently from the generation of any other entity's sketches. Advertisers, partners and publishers, for instance, provide intake data 1108 having associated metadata and location for the data access point from where data access is to be obtain. The intake data 1108 includes an advertiser or publisher's identity keys and the cadence (e.g., periodicity “T”) at which sketch generation is to occur. An entity's user data is read once at interval “T” and transformed into a collection of sketches 136 for a given entity.

The data access point employed by the advertiser or publisher may be either by reference or uploaded to a blob storage. The data read by the database service 116 is ephemeral so the reference or uploaded data is deleted after generating the sketches 136 for the entity. In a scenario involving advertiser data enrichment, after the onboarding of an audience completes, the audience identity keys are sent by RTCDP Collaboration to the any specified collaborating partners. The response provided by a partner is read and a sketch 136 is generated for the partner ID (PID).

The collection of sketches 136 generated for an entity are persisted separately for each entity within one or more database 120 associated with the entity. The sketches 136, as previously described, are solely visible to the database service 116 and do not contain confidential information 130 such as member or record level data, e.g., no email IDs, no IP addresses. This partition or area where each of the databases 120 are stored is also referred to as an “ID Free Zone.” The ID free zone does not contain membership IDs nor does this area contain any data that would allow membership IDs to be constructed or retrieved.

The database service 116 and database 120 are also operatable independent of awareness of a collaborators technology stack or cloud provider, with which, to collaborate. An advertiser or a publisher, for instance, solely provides a data access point information to the database service 116 and not to their collaborating parties. This agnosticism of other collaborators' technology stack allows the collaboration to exist across many parties at scale. The information and sketches 136 for a given entity are fully independent from any other entity's sketches.

In one or more implementations, DCRs and Publisher CAPIs are usable for providing advertiser campaign performance metrics between a single Advertiser and a single Publisher. Use of the database 120 and sketch 136 having a probabilistic data structure 138 is another such technique that provides overlap metrics, impression frequency, unique user reach and measurement performance metrics. The database service 116 goes beyond a conventional point-to-point solution by allowing for simultaneous collaboration insights that are available at browser hover speed (e.g., near real time) between a single advertiser and multiple publishers and multiple partners. Furthermore, the collaboration can span across multiple cloud providers between collaborating parties.

The database service 116 implements a compute component that is a privacy-centric, zero-data-share implementation as no entity can view or access a different entity's confidential information. Consider a scenario in which an advertiser wishes to view overlap metrics between its audience “a2” and a publisher's audience “p2.” The generated sketches are “A2” from the advertiser and “P2” from the publisher, respectively. The computation may be triggered from a UI by the advertiser.

To compute and view the metrics (e.g., as a probabilistic result), the database manager module 702 performs set operations on the sketches 136 by computing the intersection between sketches to create a new result sketch. This operation is executed at browser hover speed and is executed using the probabilistic data structures 138 which do not involve sharing of confidential information 130 between the advertiser and publisher. In this example, once the result sketch, “R1” is calculated, the audience overlap count can be returned to the UI to show the value to the advertiser.

In a scenario involving an act of sharing an audience with a publisher, advertiser exploration within the database service 116 allows the user (e.g., advertiser) to share a computed audience. The resulting audience is “materialized” into a list of membership IDs using the mapping 212. Next, the materialized list of IDs is “activated” by copying them into a location specified by the publisher.

In an advertiser/publisher data onboarding and sketch generation scenario, the database service 116 supports federated access, allowing a participating entity to specify a data access point's location. In addition, each entity may use a different cloud provider. Thus, each entity onboards a corresponding dataset 124 independently from any other entity. For parties that do not have dedicated data access points or do not wish to share their data access point, these entities can also upload the dataset 124 into a dedicated blob storage.

Once the data access point location has been identified, the dataset 124 is read by the dataset manager module 122 which then generates the appropriate entity's sketches 136. The collection of sketches 136 forms an entity's database 120. The sketches are stored independent of any other entity's sketches 136.

In an insights computation scenario, for a given collaboration, insights, including discovery, are computed using set operations against each entity's sketches 136, resulting in a temporary sketch when applicable. The solution allows an entity to scale paid media campaigns across a variety of publishers. The entity can also share their own onboarded audiences or a computed audience across many publishers.

In an audience materialization and activation scenario, an entity that wishes to share an audience can trigger the materialization and activation of said audience in a publisher's protected environment. To do so, using a sketch 136 as a starting point, materialization begins by scanning the dataset 124 in a publisher's environment. The materialization process checks membership existence in the sketch for each user ID, e.g., using the mapping 212. Once each of the members of the sketch have been identified, the membership IDS are temporarily stored.

The next step is to copy the materialized list of membership IDs into a location as specified by the publisher. The location may be a blob storage or simply an audience table, to which, the Publisher grants access. The temporary list of materialized IDs is then deleted immediately after the copy is completed.

The database service 116 and database 120 implement collaboration techniques that are privacy centric by implementing zero-data-sharing of individual user level data between collaborating parties. Sketches 136 are free from individual user level data. The dataset 124 is deleted at generation of the sketch 136 by the database service 116. These techniques support a variety of operations including overlap metrics, impression frequency, unique user reach, and measurement performance metrics based on sketches 136.

The collaboration techniques support “N”-way collaboration between advertisers, publishers, ID partners and data partners. This collaboration permits advertisers to plan campaigns and view performance metrics across collaborating parties, including publishers, data partners and ID partners. These techniques also permit collaborating entities to be agnostic of the other entity's cloud-provider and technology stack, which is not possible in conventional techniques.

### Differential Privacy Using Probabilistic Data Structures

The following discussion describes differential privacy techniques that are implementable utilizing the described systems and devices through use of a probabilistic data structure. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 17 depicts a system 1700 in an example implementation of enhancing probabilistic data structures using differential privacy. Conventional data storage techniques used for a variety of data types are typically stored in databases (e.g., relational and non-relational database), as “flat” files, and so forth. These conventional data storage techniques are relatively straightforward in that raw data is maintained along with associated IDs.

As previously described however, the associated IDs and other types of confidential information 130 are thus exposed in these conventional scenarios. For example, an audience list of “High Value Users” stores the identities of the audience IDs along corresponding attributes. The identities are configurable in a variety of ways to represent an individual entity or a group of entities, e.g., through use of email addresses, hashed email addresses, device IDs, IPV4 addresses, user accounts, legal names, and so forth.

Accordingly, in the illustrated example a differential privacy module 1702 is employed to enhance privacy of sketches 136 and probabilistic data structures 138 included in the sketches 136 generated from a dataset record 128 having confidential information 130 and an attribute 132. To do so, the differential privacy module 1702 implements differential privacy, which is a mathematical approach designed to protect individual privacy of confidential information 130 yet still support analysis of large datasets. The differential privacy module 1702, for instance, is configurable to control addition of noise to the data, which may be performed when generating a sketch 136 from a dataset record 128 as further described in relation to FIGS. 18-21 and/or reading data from a sketch 136 as further described in relation to FIGS. 21-22. For example, differential privacy may include generating a sketch and then applying noise to the sketch, parts of a dataset record which are then used to form the sketch, and so forth.

Differential privacy, for instance, is performable by the differential privacy module 1702 to add statistical noise to the inputs (e.g., when generating a sketch) and/or outputs, e.g., to a sketch returned as a result to a query. Statistical noise may be added in a variety of ways, examples of which include adding random noise in a manner that balances privacy and data utility. In another example, an Epsilon parameter is employed by the differential privacy module 1702 which is a privacy loss parameter that is usable to control an amount of noise added. Typically, a smaller value of Epsilon adds more noise and higher privacy whereas a larger value of Epsilon adds a lesser amount of noise and therefore a lower amount of privacy. In this way, differential privacy as implemented by the differential privacy module 1702 (e.g., at the database service 116 and/or the dataset manager module 122) supports data analysis without revealing the confidential information 130, e.g., individual membership IDs.

The differential privacy module 1702, for instance, is configurable to support differential privacy guarantees on data of the dataset record 128 by generating and persisting probabilistic data structures which when queried adhere to the differential privacy guarantees. The database manager module 702, therefore, is configurable to perform a variety of operations 816 based on the types of queries received while implementing differential privacy.

Illustrated examples of operations 816 as previously described in relation to FIG. 8 include a membership operation 818, cardinality operation 820, similarity operation 822, frequency operation 824, set operation 826, and so on. These examples include instances in which operations involve two or more sketches to generate a new sketch, e.g., union and intersect, “a-not-b,” and so forth.

A membership operation 818, for instance, may be used to answer a question of “whether a particular ID is present in a set.” A cardinality operation 820 is usable to answer a question of “how many IDs are present in the set.” A similarity operation 822 is used to answer a question of “how similar are two sets” as described by respective sketches whereas a frequency operation 824 is usable to answer a question of “what is a frequency of occurrence of a particular event.” A set operation 826 (e.g., intersection, union, difference) as previously described is usable on one or more sketches to generate a “new” resulting sketch.

FIG. 18 depicts a system 1800 in an example implementation showing sketch generation as a probabilistic data structure as implementing differential privacy. In the example system 1800, a computing device 104 acts as a source of a dataset record 128 which is then used as a basis to generate a sketch 136. The computing device 104, for instance, may correspond to a targeting computing device, publisher computing device, a computing device associated with a data partner or ID partner, and so on. In this example, each dataset includes a plurality of dataset records describing a respective audience as previously described, although other examples of confidential information 130 are also contemplated.

The system 1800 in the illustrated example is implemented in whole or in part by the service provider system 102, the computing device 104, (e.g., as associated with an entity), or an additional computing device 140. The computing device 104, for instance, is configurable to implement the dataset manager module 122 locally within a protected environment 1102. The service provider system 102 in this instance implements the database manager module 702 of the database 120 that maintains the sketches 136 in a shared environment as described in relation to FIGS. 2-10.

In another instance, the service provider system 102 implements both the dataset manager module 122 and the database manager module 702. The dataset manager module 122, for instance, is executable within a protected environment of the service provider system 102, e.g., to maintain a mapping. The database manager module 702, on the other hand, is executable with a shared environment of the service provider system 102, e.g., to maintain the sketches 136 within the database 120, examples of which are described in relation to FIGS. 11-16. A variety of other examples are also contemplated.

In the illustrated scenario, a sketch 136 serves as a basis for audience analysis. As previously described, probabilistic data structures 138 and a database 120 having probabilistic data structures are employed that do not include confidential information while maintaining data associated with the confidential information through the use of a “sketch.”

A sketch 136 employs a probabilistic data structure that is used to represent data in a condensed form. Sketches 136, for instance, employ algorithms (e.g., a Bloom filter, a Theta Sketch, or a MinHash), that support data representation without storing row-level information containing the confidential information 130, which ensures privacy by eliminating use of user identities, user audiences, or other confidential information. By storing a sketch 136 independent of row-level data, recovery of a corresponding user, entity, or other confidential information associated with the data is not possible. Thus, a database 120 having probabilistic data structures (e.g., the sketch) does not support direct identification of the confidential information. As a result, these techniques support compliance with privacy regulations and eliminate a risk of data leakage.

Sketches 136 are also configurable to represent data in a highly condensed form, thereby reducing an amount of data that is stored and processed. This efficiency supports faster query execution and efficient use of computational resources. Conventional queries that could take days to process by a computing device (e.g., set operations), for instance, are performable in real time using the techniques described herein.

To begin in this example, the dataset 124 is received from a respective entity that describes a respective audience. A sketch 136 is then generated by a database manager module 702 as a probabilistic data structure 138. The sketch 136, in one or more examples, is configured to remove confidential information (e.g., membership identifiers) and incorporate attributes and corresponding identity keys. The probabilistic data structure 138, for instance, is based on the identity key 208 and the attribute 132 and is independent of the membership ID 206. Further, the attributes 132 in these examples are not sampled through use of the probabilistic data structure 138, but rather included in their entirety thereby improving accuracy over conventional techniques.

The database manager module 702, for instance, is configurable to detect which identity keys are included in respective sketches 136 returned as a result a processing a query and identify respective entities that correspond to those identity keys. Confidential information may then be resolved within respective protected environments 1102 associated with the detected entities, thereby protecting this information from compromise by malicious parties and improved operational and computational efficiency.

In the illustrated example, the differential privacy module 1702 is implemented by the dataset manager module 122 as part of sketch 136 generation. The differential privacy module 1702 is configured to transform data of the dataset record 128 into a version as part of the sketch 136 that is “non-re-identifiable,” e.g., using addition of noise, encryption, encoding, and so forth. The differential privacy module 1702, for instance, is configurable to add noise to individual sketches based off a variety of factors such as “how many sets of data are available for querying,” a size of the sets, and so forth. The differential privacy module 1702 is also configurable to employ minimum aggregation results, e.g., to ensure that if any non-zero result is below a particular minimum aggregation threshold that result is returned as an answer to the query.

FIG. 19 depicts a system 1900 in an example implementation showing operation of the differential privacy module 1702 in greater detail as part of sketch generation. The differential privacy module 1702 in this example is employed as part of an indexing process of the sketch generation module 210 to generate a sketch 136 from a dataset record 128. As before, the dataset record 128 includes an identity key 208, confidential information 130, and corresponding attribute 132. Through use of the differential privacy module 1702, data is included in the sketch 136 in a form (e.g., for the identity key) that is incapable of being re-identified or recreated based on the data within the sketch 136 itself.

To do so in the illustrated example, the differential privacy module 1702 includes a noise generation module 1902 implemented to generate noise 1904, an encryption/decryption module 1906 employing one or more cryptographic keys 1908, and an encoding/decoding module 1910. The differential privacy module 1702 is configurable to implement differential privacy to a variety of types of data included in the dataset record 128, e.g., the identity key 208, the confidential information 130, the attribute 132, and so forth.

The differential privacy module 1702, for instance, is configured to receive an identity key 208 as a hashed email, IPv4 address, user alias, and so forth. The encryption/decryption module 1906 is configured to then employ a cryptographic key 1908 (e.g., a private key) to transform a distribution of the dataset record 128 into a pseudo-random distribution using a cryptographic function, e.g., AES 256. The encryption/decryption module 1906 is also configurable to employ “salt” as a random piece of data added to an input of a hash function to ensure an output is unique, even for identical inputs. A unique salt, for instance, is generated by the encryption/decryption module 1906 for each piece of data. This salt is then combined with the data before hashing. The combination of the salt and the data is hashed together, producing a unique hash value. The one or more cryptographic keys 1908 and the salt are maintained within a protected environment 1102 of the database service 116.

In another instance, the differential privacy techniques are configured in support of a foundation for creating overlaps across targeting computing devices and publisher computing devices by guaranteeing identical outputs given identical inputs. Likewise, cryptographic encryption like AES, certain block cipher modes (CBC, for example) utilize an Initialization Vector (IV) that is typically randomized for each input. In this instance, however, a constant IV is utilized across each of the inputs to guarantee a same input is hashed to a same output. Accordingly, in this instance the same salt and same IV are stored and used for each of the inputs.

The encoding/decoding module 1910 is then employed in this example to transform an output of the encryption/decryption module 1906. The output of the encryption/decryption module 1906, for instance, has twenty-six bits in an “AES 256” example. The encoding/decoding module 1910 is then configured to transform that output into sixty four bits using a deterministic function. The decoding module 1910, for instance, may select a “first 64 bits” of the input, average every four bits, and so forth.

The differential privacy module 1702 is configurable to employ a variety of approaches as part of sketch 136 generation that support a variety of operations by the database manager module 702, e.g., cardinality estimation, set operation similarity, and so forth as previously described in relation to FIG. 18. The differential privacy module 1702, for instance, obtains a total number of datasets for each collaborating entity. The differential privacy module 1702 then obtains a total number of possibilities of interaction between the dataset counts, i.e., a cross-product count.

For example, if a first collaborator has five sets of data and a second collaborator has ten sets of data, a total number of possibilities is bounded by “(five plus one) multiplied by (ten plus one) equals sixty six possible combinations.” The additional value of “one” added to each of the sets of data is used to denote an implicit union of each of the sets present for each respective collaborating entity.

The differential privacy module 1702 then obtains a noise ID count based on a function which is dependent on a size of the set, total possible set combinations, and Epsilon, e.g., a user defined privacy parameter that is defined or inferred by the differential privacy module 1702. The noise generation module 1902 is then employed by the differential privacy module 1702 to generate “noisy IDs to add” and generate a “noise clean sketch” which is stored alongside an original sketch that does not have the noise 1904 added.

Therefore, when the database manager module 702 receives a query 802, operations 816 are triggered to generate a result as a sketch 136 having a probabilistic result 804, e.g., by performing a union operation using the “noise clean sketch.” For a query 802, the added noise is subtracted by the database manager module 702 before returning the result.

FIG. 20 depicts a system 2000 in an example implementation showing performance of union operations by the database manager module 702 using sketches. For a typical union operation 2002, a sketch 2004 including a theta sketch and bloom filter is “union-ed” with a sketch 2006 that also includes a theta sketch and a bloom filter, which results in a sketch result 2008 having a union of the theta sketches and a union of the bloom filters.

Similar techniques may also be used for sketch generation using differential privacy and thus are “noisy,” i.e., have noise 1904 added. For this union operation 2010, a sketch 2012 including a theta sketch and bloom filter is “union-ed” with a noisy sketch 2014 that also includes a theta sketch and a bloom filter. A noise-induced sketch result 2016 is then output having a union of the theta sketches and a union of the bloom filters.

For membership operations, a different approach may be implemented to address an underlying nature of bloom filters, cuckoo filters, and other probabilistic data structures. These probabilistic data structure vary in nature in which a bit or set of bits in these structures represent presence of a particular ID (e.g., identity key) in it.

Therefore, in one or more examples, instead of using noise-induced IDs, a bit flip approach is utilized by the noise generation module 1902 of the differential privacy module 1702 in which “bits are flipped” in a probabilistically-biased manner (e.g., from “ones” to “zeros” and vice versa) based on one or more parameters. Examples of these parameters include a maximum size of a membership query based probabilistic data structure (e.g., bloom filter) used in the sketch 136, cardinality of membership query based probabilistic data structure, Epsilon which is a privacy parameter that may be defined or inferred by the differential privacy module 1702, and so forth.

Therefore, in this example a “noise flipped membership probabilistic data structure” is formed through processing using a bit-flip function of the noise generation module 1902. Based on the value of the noise and other parameters, a “new” instance of the probabilistic data structure 138 is formed that, when queried, includes a mix of false positives and false negatives. For a false positive, an ID (i.e., identity key) which is not present in the dataset record 128 used to generate the sketch 136 falsely shows as present. For a false negative, an ID (i.e., identity key) which was originally present in the dataset record 128 used to generate the sketch 136 falsely shows as not being present. In this way, differential privacy guarantees are implemented such that given multiple iterations of querying the data there is no guarantee that a particular ID will be present depending on how the bits are flipped for each iteration.

Given a set of collaborating entities including a targeting computing device and a publisher computing device, for instance, an audience set of IDs is materialized based on an initial audience of the targeting computing. An “isPresent ( )” function is employed by the database manager module 702 that is defined on a membership query based probabilistic data structure.

To begin in this example, a sketch is fetched from the database 120 for an audience associated with the targeting computing device which is then processed by a differential privacy module 1702, e.g., using a bit flip function. An “ephemeral list” is also generated of actual identity keys (e.g., publisher IDs) to be materialized. For a publisher ID, for instance, the function is applied to the sketch having the applied noise and a difference is calculated between the ephemeral list and a minimum aggregation count as follows:
Aggregation_count_difference=minimum_aggregatin_count−COUNT(ephemerallist)
   The “noisy IDs” are then added based on this processing. This technique ensures both false positives and false negatives are encapsulated into a resultant materialized output as well as making sure a minimum aggregation threshold is met.

In this way, the differential privacy module 1702 ensures that it is not possible to derive information on a particular ID through cardinality estimates or intersections across multiple sketches. Additionally, it is not possible to guarantee existence of a particular ID in a resultant materialization of a sketch since members checks are also differentially privacy safe, thereby preserving the confidential information 130.

A malicious party, for instance, may wish to create a set of data using a single identity key (e.g., ID) associated with a collaborator and then wish to check membership and materialize using another collaborator's audience. By implementing minimum thresholding as well as introduction of false positives and false negatives, the differential privacy module 1702 protects against compromise by the malicious party. A particular output size (e.g., two hundred), for instance, is provided even if an actual intersection is “one” based on the malicious party's input and the materialize list that have other “noisified” IDs and without a guarantee that an actual ID is present.

FIG. 21 depicts a system 2100 in an example implementation showing sketch generation as probabilistic data structure as implementing differential privacy in a probabilistic result 804 to a query 802. FIG. 22 depicts a system 2200 in an example implementation showing operations of a database and a result of those operations being processed using differential privacy in a probabilistic result 804 to a query 802. In the previous examples, the differential privacy module 1702 is employed to incorporate differential privacy through addition of noise to sketches formed based on a dataset record 128. In these examples, differential privacy is employed to a result, e.g., a sketch, generated in response to a query 802.

These techniques may be utilized separately or in combination with the previously described techniques. The differential privacy module 1702, for instance, may receive a sketch 136 that is “clean” in response to a query 802 and then implement differential privacy techniques to add noise. The differential privacy module 1702, for instance, may employ the noise generation module 1902, the encryption/decryption module 1906, and/or the encoding/decoding module 1910 as previously described in relation to FIG. 19. These techniques may also be employed to decode, decrypt, and remove noise by the differential privacy module.

FIG. 23 is a flow diagram depicting an algorithm as a step-by-step procedure 2300 in an example implementation of operations performable for accomplishing a result of differential privacy using probabilistic data structures. To begin in this example, a dataset record is received (block 2302). A sketch is generated as a probabilistic data structure (block 2304). As part of generating the sketch, noise is applied to the dataset record using a differential privacy technique (block 2304), through a bit-flip technique, random noise, and so forth.

The sketch is then communicated to be stored in a database that supports a probabilistic result to a query operation (block 2308). Accordingly, upon receipt of a query (block 2310), a probabilistic result is generated by processing the query using the database (block 2312). The probabilistic result is then presented for output in a user interface (block 2314).

### Example System and Device

FIG. 24 illustrates an example system generally at 2400 that includes an example computing device 2402 that is representative of one or more computing systems and/or devices that implement the various techniques described herein. This is illustrated through inclusion of the database service 116 and the dataset manager module 122. The computing device 2402 is configurable, for example, as a server of a service provider, a device associated with a client (e.g., a client device), an on-chip system, and/or any other suitable computing device or computing system.

The example computing device 2402 as illustrated includes a processing device 2404, one or more computer-readable media 2406, and one or more I/O interface 2408 that are communicatively coupled, one to another. Although not shown, the computing device 2402 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 2404 is representative of functionality to perform one or more operations using hardware. Accordingly, the processing device 2404 is illustrated as including hardware element 2410 that is configurable as processors, functional blocks, and so forth. This includes implementation in hardware as an application specific integrated circuit or other logic device formed using one or more semiconductors. The hardware elements 2410 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 2406 is illustrated as including memory/storage 2412 that stores instructions that are executable to cause the processing device 2404 to perform operations. The computer-readable storage medium is configured for storing instructions that, responsive to execution by the processing device, causes the processing device to perform operations. The memory/storage 2412 represents memory/storage capacity associated with one or more computer-readable media. The memory/storage 2412 includes volatile media (such as random access memory (RAM)) and/or nonvolatile media (such as read only memory (ROM), Flash memory, optical disks, magnetic disks, and so forth). The memory/storage 2412 includes fixed media (e.g., RAM, ROM, a fixed hard drive, and so on) as well as removable media (e.g., Flash memory, a removable hard drive, an optical disc, and so forth). The computer-readable media 2406 is configurable in a variety of other ways as further described below.

Input/output interface(s) 2408 are representative of functionality to allow a user to enter commands and information to computing device 2402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2402 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 2402. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 2402, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 2410 and computer-readable media 2406 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 2410. The computing device 2402 is configured to implement particular instructions and/or functions corresponding to the software and/or hardware modules. Accordingly, implementation of a module that is executable by the computing device 2402 as software is achieved at least partially in hardware, e.g., through use of computer-readable storage media and/or hardware elements 2410 of the processing device 2404. The instructions and/or functions are executable/operable by one or more articles of manufacture (for example, one or more computing devices 2402 and/or processing devices 2404) to implement techniques, modules, and examples described herein.

The techniques described herein are supported by various configurations of the computing device 2402 and are not limited to the specific examples of the techniques described herein. This functionality is also implementable all or in part through use of a distributed system, such as over a “cloud” 2414 via a platform 2416 as described below.

The cloud 2414 includes and/or is representative of a platform 2416 for resources 2418. The platform 2416 abstracts underlying functionality of hardware (e.g., servers) and software resources of the cloud 2414. The resources 2418 include applications and/or data that can be utilized while computer processing is executed on servers that are remote from the computing device 2402. Resources 2418 can also include services provided over the Internet and/or through a subscriber network, such as a cellular or Wi-Fi network.

The platform 2416 abstracts resources and functions to connect the computing device 2402 with other computing devices. The platform 2416 also serves to abstract scaling of resources to provide a corresponding level of scale to encountered demand for the resources 2418 that are implemented via the platform 2416. Accordingly, in an interconnected device embodiment, implementation of functionality described herein is distributable throughout the system 2400. For example, the functionality is implementable in part on the computing device 2402 as well as via the platform 2416 that abstracts the functionality of the cloud 2414.

In implementations, the platform 2416 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a dataset record;
generating, by the processing device, a sketch as a probabilistic data structure, the generating including applying noise to the dataset record; and
communicating, by the processing device, the sketch to be stored in a database that supports a probabilistic result to a query operation.

2. The method as described in claim 1, wherein the applying of the noise to the dataset record is performed using a differential privacy technique.

3. The method as described in claim 1, wherein the applying of the noise is performed using a bit-flip technique.

4. The method as described in claim 1, wherein the dataset record includes an identity key, a respective attribute, and confidential information.

5. The method as described in claim 4, wherein the applying of the noise to the dataset record includes applying the noise to the identity key of the dataset record.

6. The method as described in claim 4, wherein the sketch, as stored in the database, does not support direct identification of the confidential information via the database.

7. The method as described in claim 4, wherein the confidential information is a membership identifier (ID) of a respective entity associated with the attribute for the identity key.

8. The method as described in claim 4, further comprising:
forming a query for processing by the database;
receiving a probabilistic result to the query from the database; and
resolving the sketch, as included in the probabilistic result, to the confidential information based on a mapping.

9. The method as described in claim 1, further comprising forming a mapping of confidential information included in the dataset record to the sketch and wherein the sketch is configured to be stored independent of the confidential information.

10. The method as described in claim 9, wherein the mapping is configured to resolve the sketch as included in the probabilistic result to the confidential information.

11. The method as described in claim 1, wherein the generating and the applying are performed in a protected environment and the data that supports the probabilistic result is maintained in a shared environment.

12. A computing device comprising:
a processing device; and
a computer-readable storage medium storing instruction that, responsive to execution by the processing device, causes the processing device to perform operations including:
receiving a query for processing by a database;
generating a probabilistic result by processing the query using the database based on a corresponding operation, the database including a plurality of sketches, each said sketch configured as a probabilistic data structure using a differential privacy technique; and
presenting the probabilistic result for output in a user interface.

13. The computing device as described in claim 12, wherein the differential privacy technique is configured to apply noise to a dataset record used to form a sketch included in the probabilistic result.

14. The computing device as described in claim 12, wherein the differential privacy technique includes a bit-flip technique.

15. The computing device as described in claim 12, wherein the probabilistic result includes a sketch formed based on an operation performed using one or more of the plurality of sketches included in the database.

16. The computing device as described in claim 15, wherein the one or more sketches are generated using the differential privacy technique.

17. One or more computer-readable storage media storing instructions that, responsive to execution by a processing device, causes the processing device to perform operations including:
generating a sketch as a probabilistic data structure based on a dataset record using a differential privacy technique; and
communicating the sketch to be stored in a database that supports a probabilistic result to a query operation.

18. The one or more computer-readable storage media as described in claim 17, wherein the differential privacy technique is configured to apply noise to the dataset record.

19. The one or more computer-readable storage media as described in claim 17, wherein the differential privacy technique includes a bit-flip technique.

20. The one or more computer-readable storage media as described in claim 17, wherein the probabilistic result includes a sketch formed based on an operation performed using one or more of a plurality of sketches included in the database, in which, the one or more sketches are generated using the differential privacy technique.
